(19) United States
(12) Patent Application Publication
(10) Pub. No.: US 2025/0292592 A1
(43) Pub. Date: Sep. 18, 2025

(54) FEATURE GENERATION OF DASHED LINE COMPONENTS FOR AUTONOMOUS SYSTEMS AND APPLICATIONS

(71) Applicant: NVIDIA Corporation, Santa Clara, CA (US)

(72) Inventors: Yu Zhang, Sunnyvale, CA (US); Alok Kumar Gupta, Cupertino, CA (US)

(21) Appl. No.: 18/606,899

(22) Filed: Mar. 15, 2024

(51) Int. Cl. G06V 20/56; G01S 17/89; G06V 10/44; G06V 10/77; G06V 10/88

(52) U.S. Cl. CPC G06V 20/588; G01S 17/89; G06V 10/44; G06V 10/7715; G06V 10/89

(57) ABSTRACT

In various examples, systems and methods described herein may determine individual components of a dashed line based at least on identifying relationships across different portions of the dashed line. For instance, input data representing a road surface may be analyzed and a representation associated with a dashed line may be determined. In some instances, the representation may be generated based at least on intensity values associated with points corresponding to the input data. Then, based at least on the representation, information associated with one or more components of the dashed line may be determined. For instance, the representation may be indicative of the relationships across the different portions of the dashed line, and these relationships may be used to determine the information associated with the one or more components of the dashed line.

### BACKGROUND

Localization may often be a critical part of self-driving technology that allows an autonomous or semi-autonomous vehicle or machine to determine its precise position within an environment. Accurate localization may be fundamental to safe and effective navigation, allowing autonomous vehicles and systems to understand their location on the road, adhere to traffic rules, and make informed decisions based on their surroundings. In some cases, autonomous vehicles may rely on maps-such as navigational, standard definition (SD), and/or high-definition (HD) maps-corresponding to an environment in which the vehicles intend to operate. These maps may include information such as lane markings, road signs, traffic signals, and even details about the surrounding environment like buildings and landmarks. In some instances, the maps may serve as a reference for localization, allowing the autonomous system to cross-check (near) real-time sensor data with pre-existing map information for precise positioning.

Because autonomous and semi-autonomous vehicles or machines need to accurately detect and understand road features, including lane boundaries, road signs, and traffic markings, it is imperative that the map data relied upon by these systems is as accurate as possible for precise localization. To ensure map data can be as accurate as possible, features within the map data, including, but not limited to, lane line markings, road signs, and traffic markings, may be manually and/or automatically labeled to ensure accuracy. However, certain features, such as dashed lane lanes and/or other dashed lane borders, require users to manually verify and/or label, which may require a large amount of human resources and/or time. Additionally, users may make mistakes when verifying and/or labeling such features, such as by omitting a label for a dashed lane or inaccurately labeling the dashed lane line.

### SUMMARY

Embodiments of the present disclosure relate generally to feature generation of dashed line components for autonomous and semi-autonomous systems and applications. For instance, systems and methods described herein may automatically extract individual components (e.g., stripes, dashes, markings, etc.) of a dashed lane line or other dashed road surface marking by identifying relationships (e.g., periodical patterns) across different portions of the dashed lane line. For instance, input data (e.g., map data, tile image, intensity image, etc.) including a labeled, dashed line feature associated with a road surface may be analyzed in order to generate a representation (e.g., 1D signal, a 2D signal, etc.) associated with the dashed line. In some examples, the representation may be generated based at least on intensity values (e.g., LiDAR intensity values) associated with points (e.g., pixels) corresponding to the input data. Then, based at least on the representation, information (e.g., locations, lengths, widths, starting points, end points, intensities, etc.) associated with one or more components of the dashed line may be determined. For instance, the representation may be indicative of the relationships across the different portions of the dashed line, and these relationships may be used to determine the information associated with the one or more components of the dashed line. Systems and methods are then further disclosed to perform various actions including, but not limited to, updating the map data with the information associated with the dashed line components, for instance, by labeling the one or more components of the dashed line as individual features in the map data, and/or training a perception system, or one or more model(s) thereof, of a machine.

In contrast to conventional systems, such as those described above, the current systems, in some embodiments, may automatically identify and extract components of a dashed line or other drivable surface marking from input data with high precision by leveraging relationships across different portions of the dashed line. Additionally, in contrast to the conventional systems, the current systems, in some embodiments, provide techniques for updating map data (e.g., an HD map for use by a machine) with labels to identify the one or more components of the dashed line as individual features in the map data. That is, instead of the map data including a single feature and/or label corresponding to the entire dashed line, the map data may be updated to include one or more respective features and/or labels for one or more of the components of the dashed line. As such, and as described in more detail herein, by performing such processes, the current systems may automatically extract dashed line components and update map data accordingly. This provides improvements over the conventional systems that require users to manually label hundreds and/or thousands of components of a dashed line, which may require a large amount of human resources and/or time. Additionally, by automatically identifying the dashed line component(s) and/or automatically updating the map data, the current systems may more accurately label the map data as compared to the conventional systems that are more prone to user error.

### BRIEF DESCRIPTION OF THE DRAWINGS

The present systems and methods for feature generation of dashed line components for autonomous and semi-autonomous systems and applications are described in detail below with reference to the attached drawing figures, wherein:

FIG. 1 is a data flow diagram illustrating an example process of determining feature data associated with dashed line components, in accordance with some embodiments of the present disclosure;

FIG. 2 is a data flow diagram illustrating an example process of determining a representation associated with a dashed line component(s), in accordance with some embodiments of the present disclosure;

FIG. 3 illustrates an example map 300 including a dashed line feature, in accordance with some embodiments of the present disclosure;

FIGS. 4A-4E collectively illustrate example detail associated with determining a representation associated with a dashed line component(s), in accordance with some embodiments of the present disclosure;

FIG. 5 illustrates an example Fast Fourier Transform (FFT) analysis of a representation associated with a dashed line, in accordance with some embodiments of the present disclosure;

FIG. 6 is a flowchart illustrating an example method for determining information (e.g., locations, sizes, patterns, etc.) associated with components of a dashed line, in accordance with some embodiments of the present disclosure;

FIG. 7 is a flowchart illustrating an example method for determining a representation associated with a dashed line, in accordance with some embodiments of the present disclosure;

FIG. 8A is an illustration of an example autonomous vehicle, in accordance with some embodiments of the present disclosure;

FIG. 8B is an example of camera locations and fields of view for the example autonomous vehicle of FIG. 8A, in accordance with some embodiments of the present disclosure;

FIG. 8C is a block diagram of an example system architecture for the example autonomous vehicle of FIG. 8A, in accordance with some embodiments of the present disclosure;

FIG. 8D is a system diagram for communication between cloud-based server(s) and the example autonomous vehicle of FIG. 8A, in accordance with some embodiments of the present disclosure;

FIG. 9 is a block diagram of an example computing device suitable for use in implementing some embodiments of the present disclosure; and

FIG. 10 is a block diagram of an example data center suitable for use in implementing some embodiments of the present disclosure.

### DETAILED DESCRIPTION

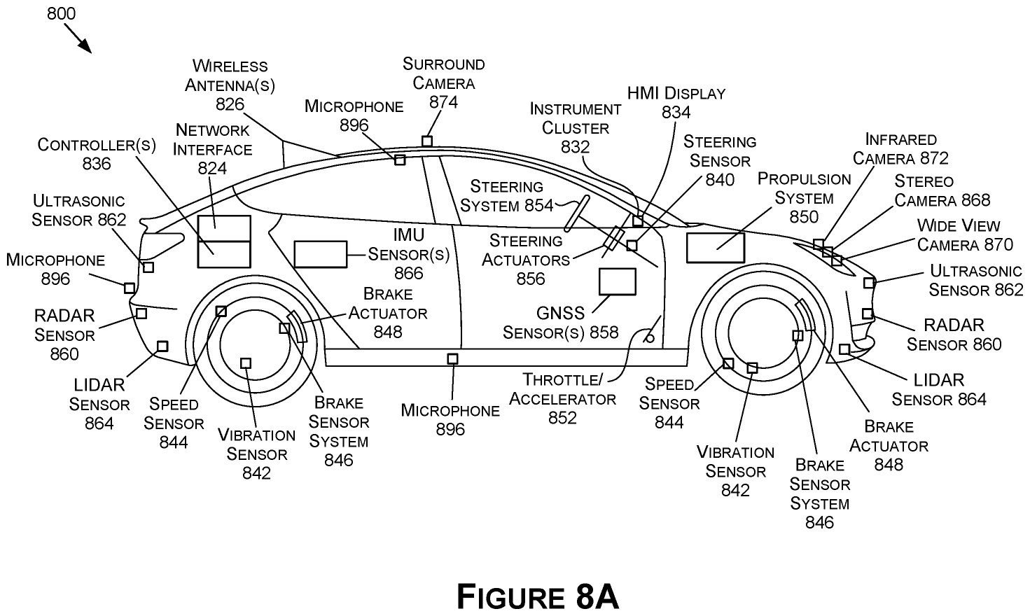

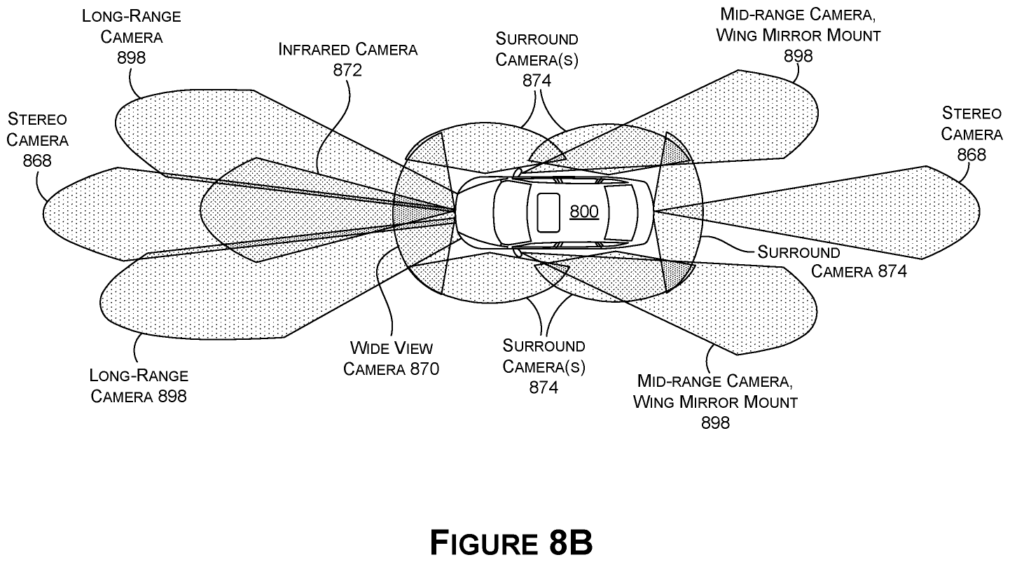

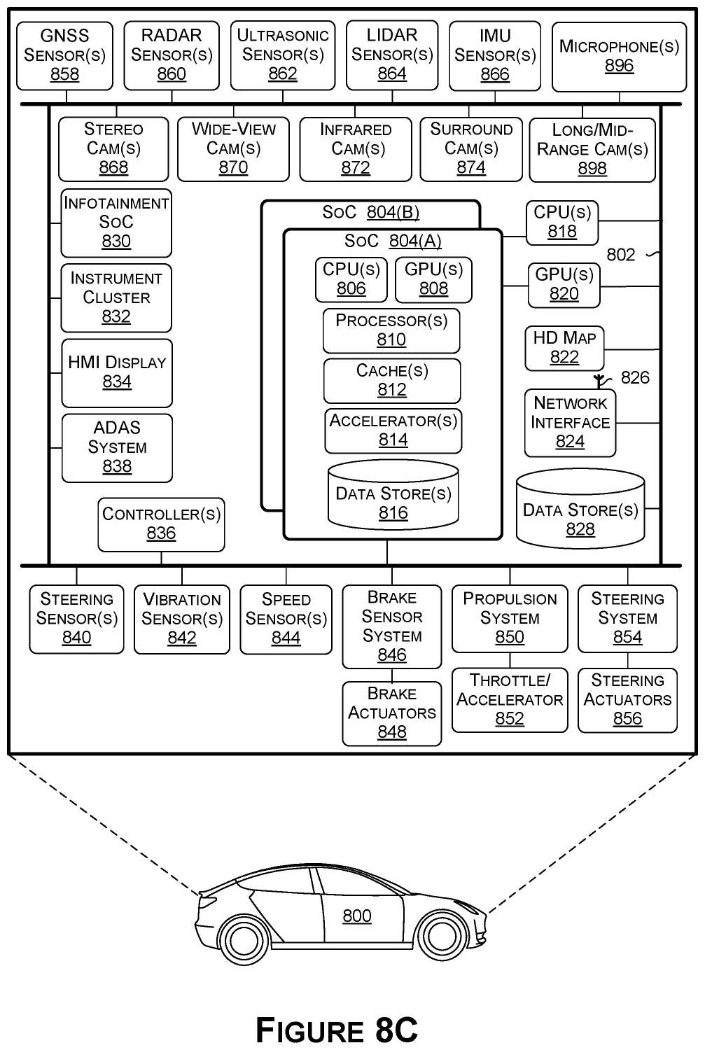

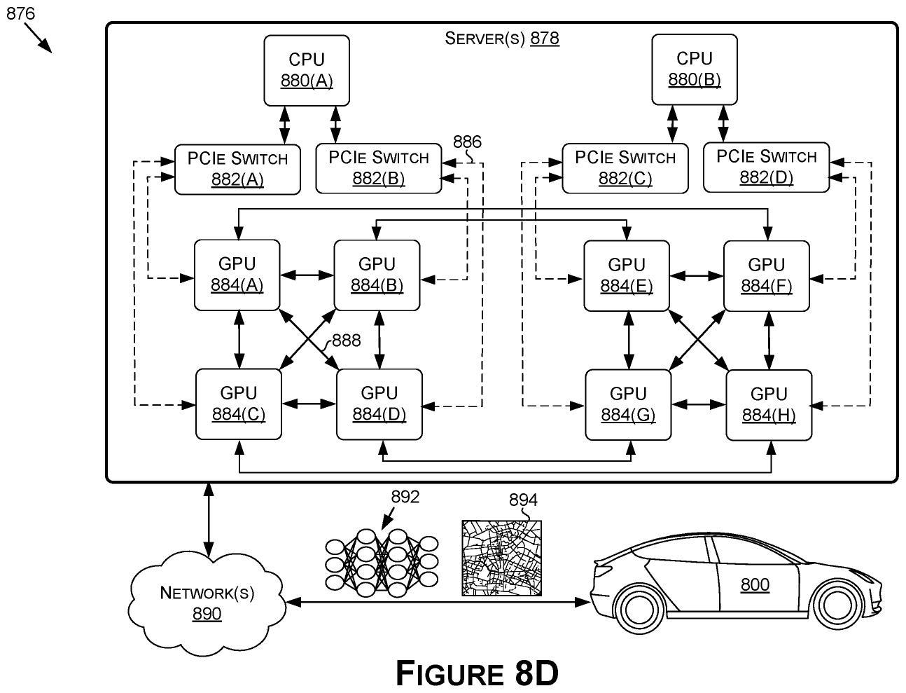

Systems and methods are disclosed related to feature generation of dashed line components for autonomous and semi-autonomous systems and applications. Although the present disclosure may be described with respect to an example autonomous or semi-autonomous vehicle or machine 800 (alternatively referred to herein as “vehicle 800,” “ego-vehicle 800,” “ego-machine 800,” or “machine 800,” an example of which is described with respect to FIGS. 8A-8D), this is not intended to be limiting. For example, the systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. In addition, although the present disclosure may be described with respect to feature detection and/or map feature generation, this is not intended to be limiting, and the systems and methods described herein may be used in augmented reality, virtual reality, mixed reality, robotics, security and surveillance, autonomous or semi-autonomous machine applications, and/or any other technology spaces where object or feature detection and/or map creation may be used.

For instance, a system(s) may obtain input data representing a dashed line or other surface marking associated with a drivable surface. In some examples, the input data may include a dashed line feature and an aerial-view (e.g., birds-eye view (BEV), top-down view, etc.) image. In some examples, the dashed line feature and/or the image may be determined or otherwise obtained from mapping data. In some examples, the image may be an intensity image generated from LiDAR data, where one or more points or pixels within the image may be associated with one or more intensity values indicative of a strength or amplitude of a reflected laser pulse from a surface at that location in the environment. In such intensity images, and as described in further detail below and illustrated in the accompanying figures, certain features associated with a road surface, such as lane lines, may correspond with higher intensity values, whereas other features associated with the road surface, such as bare asphalt, concrete, etc., may correspond with lower intensity values.

In some examples, the system(s) may generate a representation associated with the dashed line based at least on intensity values associated with points corresponding to the input data. That is, based at least on the intensity values in the input data, the system(s) may determine a representation associated with the dashed line. In some examples, the representation may include a 1D signal that may be plotted with respect to a first axis (e.g., vertical axis) and a second axis (e.g., horizontal axis). For instance, the first axis may correspond with intensity values and the second axis may correspond with point location and/or point distance from an origin. In this way, a data point associated with the representation may be plotted by projecting a point's intensity value and location/distance with respect to the first axis and second axis.

In some examples, for the system(s) to generate the representation associated with the dashed line, the system(s) may perform one or more preliminary and/or constituent operations. For instance, these preliminary/constituent operations may include, but are not be limited to, segmenting the input data by projecting bounding shapes along the dashed lane-line, orienting portions of the input data included in the one or more bounding shapes, determining segmented representation(s) associated with the portions of the dashed line represented in the one or more bounding shapes, concatenating one or more of the segmented representation(s), and performing a Fast Fourier Transform (FFT) analysis on the concatenated representation(s).

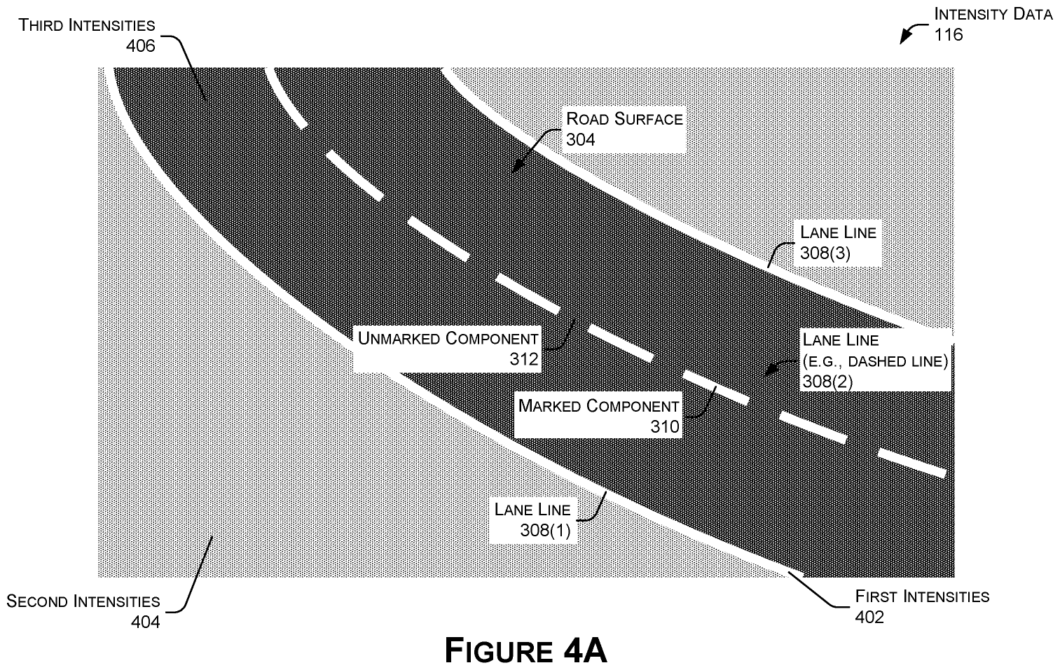

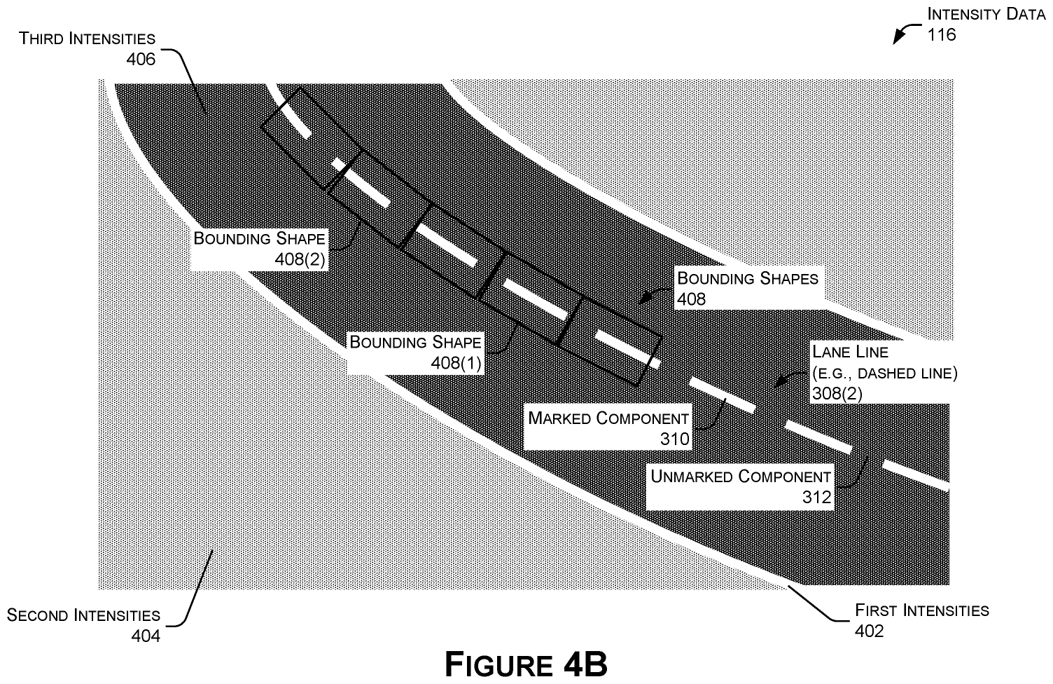

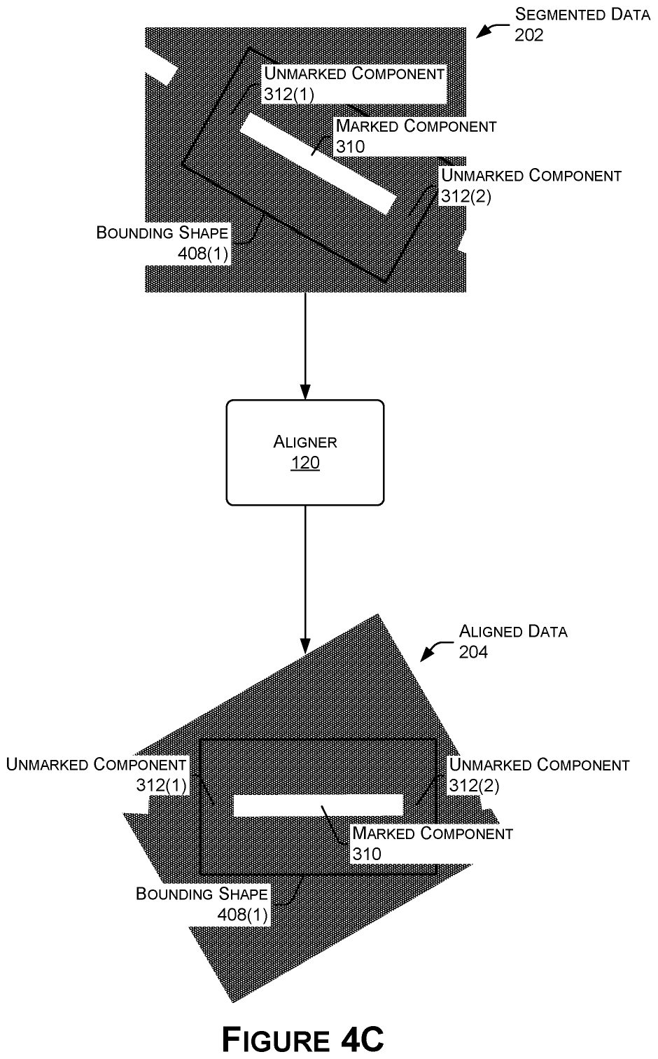

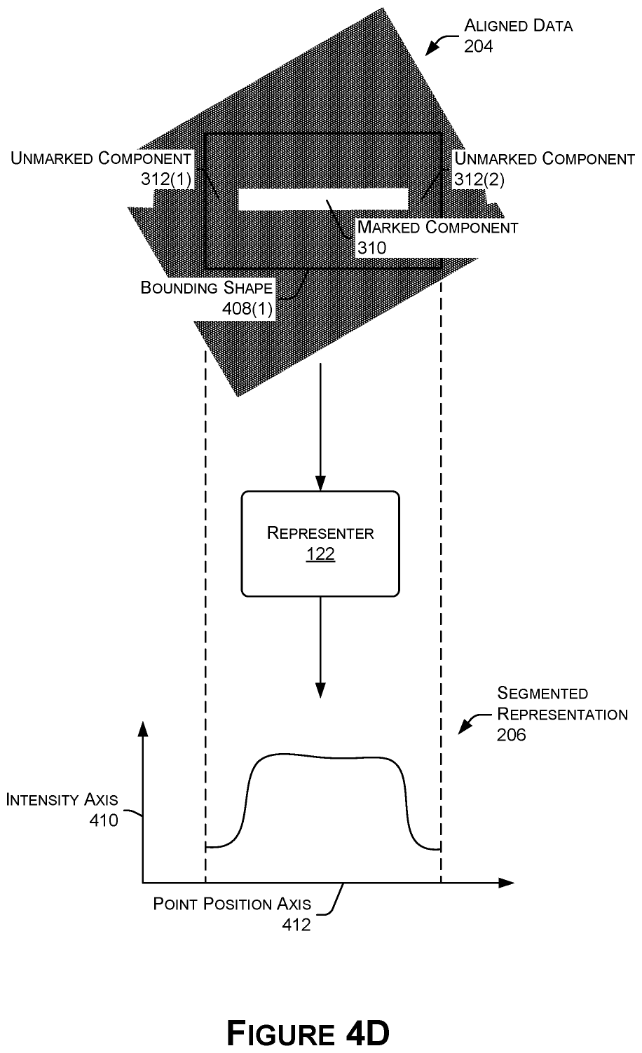

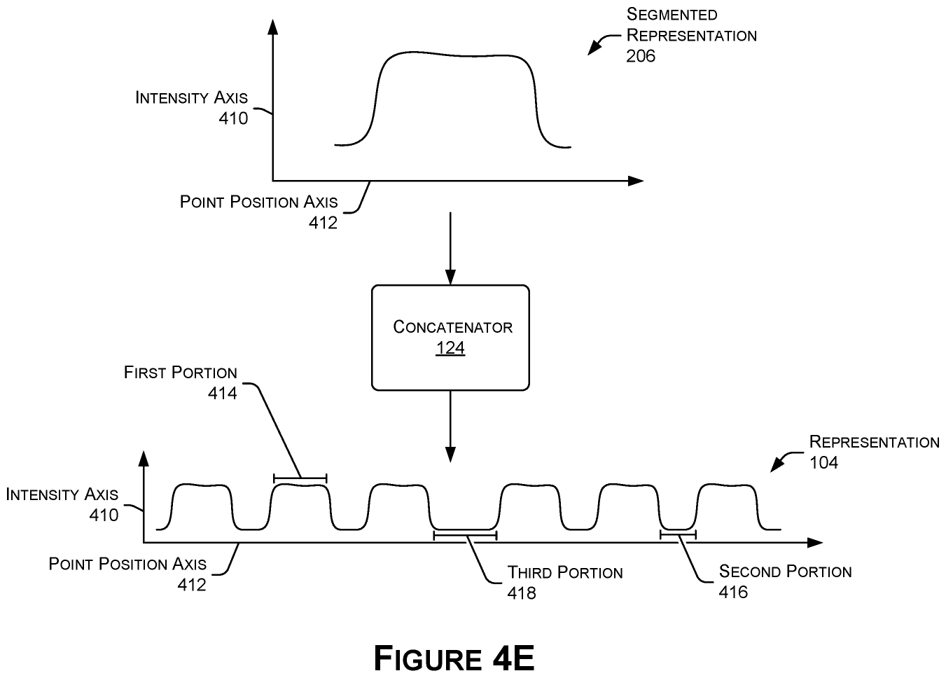

In some examples, the system(s) may segment the input data by determining bounding shapes along the dashed line. For instance, and as illustrated and explained in further detail below with reference to FIG. 4B, one or more bounding shapes (e.g., windows) may be projected along the dashed line to segment the input data and/or the dashed line into smaller portions of data for easier processing. For instance, the system(s) may determine a first bounding shape along the dashed line and a second, distinguishable bounding shape along the dashed line. In some instances, the first bounding shape may correspond to a first portion of the representation that may be associated with a first segment of the dashed line, and the second bounding shape may correspond to a second portion of the representation that may be associated with a second segment of the dashed line.

Additionally, by segmenting the input data into smaller portions, downstream operations may be performed in parallel, thereby allowing for faster and more efficient processing of the input data to generate a representation associated with a dashed line. Furthermore, by segmenting the dashed line into multiple segments/portions, the system(s) may more easily and consistently generate a representation for dashed lines that include curvature, bends, angles, and/or the like.

In some examples, the bounding shapes may be projected onto the input data such that the bounding shapes may be non-overlapping (e.g., a first bounding shape is proximate to a second bounding shape, but does not overlap the second bounding shape, and so forth). Additionally, in some examples, the one or more bounding shapes may be positioned along a centerline of the dashed line. That is, the dashed line and/or a centerline associated with the dashed line may divide the bounding shape into two substantially equivalent sized and/or shaped portions.

In some examples, the bounding shapes may be different shapes and/or sizes. For instance, in one example, a bounding shape may enclose an area that may be 2 feet wide by 4 feet long and, in another example, a bounding shape could enclose an area that may be 1 meter wide by 2 meters long, (although these are only example dimensions and, in other example, other dimensions may be used). Additionally, or alternatively, in some examples, the sizes of a bounding shape may be in dimensions of points or pixels (e.g., 100 points wide by 400 points long). In some examples, the length of a bounding shape may be based at least on a magnitude of curvature of a lane line. For instance, in a scenario where the lane line may be substantially straight, a longer bounding shape may be used. However, in a different scenario where the lane line bends (e.g., a corner) a shorter bounding shape may be used.

In some examples, the system(s) may orient the segmented input data for analysis by rotating portion(s) of the input data included within the one or more bounding shapes. For instance, and as illustrated and explained in further detail below with reference to FIG. 4C, the segmented input data may be oriented for analysis, however this may not always be the case (e.g., a dashed line that is substantially horizontal in the input data). In some examples, orienting the segmented input data may include projecting points within the bounding shape to a horizontal or vertical frame. In some examples, the system(s) may orient the first bounding shape (and/or the points within the first bounding shape) with respect to the second bounding shape (and/or the points within the second bounding shape). In some examples, the system(s) may rotate different portions of the input data and/or the different bounding shapes by different magnitudes of rotation. For instance, the system(s) may rotate a first bounding shape and its points therein by a first number of degrees while rotating a second bounding shape and its respective points by a second number of degrees. In examples, the differences in rotation may be based on an angle of the dashed line with respect to a horizontal axis associated with the input data. After the segmented data and/or the bounding shapes are rotated, the points within the bounding shapes may be logically partitioned into different rows and columns.

In some examples, after orienting the segmented data, the system(s) may determine the representation(s) (e.g., 1D signal(s)) associated with the portions of the dashed line represented in the one or more bounding shapes. For instance, for the input data included in a first bounding shape of the one or more bounding shapes, the system(s) may determine a first intensity value (e.g., first overall intensity value) based at least on one or more of the intensity values within a first column of the points within the bounding shape. Additionally, the system(s) may determine a second intensity value (e.g., second overall intensity value) based at least on one or more of the intensity values included in a second column of the points within the bounding shape. That is, the first intensity value and the second intensity value may be a sum or an average of all the intensity values included in the first column and the second column, respectively. In examples, the system(s) may cause the first intensity value to be plotted as a first data point of the representation, cause the second intensity value to be plotted as a second data point of the representation, and so forth. In some examples, a column that does not include any marked components of a dashed line (e.g., includes only unmarked components), may have a low overall intensity value, whereas a column that includes marked components of the dashed line (e.g., does not include unmarked components of the line) may have a higher overall intensity value.

In some examples, the system(s) may concatenate one or more of the segmented representation(s). That is, because the segmented representation(s) may be generated based on a segment or portion of the dashed line, to determine a full representation of the entire line, or simply a representation of a larger portion/segment of the line, the system(s) may concatenate one or more of the segmented representations of the dashed line. In examples, the concatenation of the segmented representations may piece together the segmented representations to represent the whole line.

In some examples, the system(s) may also perform a Fast Fourier Transform (FFT) analysis (and/or other type of frequency analysis) on the concatenated representation(s). The FFT analysis may, in some instances, transform the representation (e.g., signal) from its original domain to a frequency domain. The FFT analysis may allow the system(s) to compute a frequency associated with the representation and/or a period associated with the frequency. Using the period and/or the frequency, the system(s) may further be able to determine locations associated with dashed line components (e.g., starting locations, ending locations, etc.), distances between dashed line components, a length of a marked component of the line, a length of an unmarked component of the line, as well as other relationships between different portions of the dashed line. In some instances, these relationships may be determined based at least on the representation. Additionally, or alternatively, these relationships may be determined based at least on the FFT analysis of the representation.

In some examples, the system(s) may determine relationships between different portions or sections of the dashed line to determine where marked components and unmarked components of the dashed line may be located. For instance, the system(s) may determine, based at least on the representation, that the first portion of the dashed line may be associated with one or more first intensity values while the second portion of the dashed line may be associated with one or more second intensity values. Additionally, the system(s) may determine that the one or more first intensity values are greater than the one or more second intensity values. Based at least on this information, the system(s) may determine that the first portion of the dashed line includes a first component (e.g., first marked component) and the second portion of the dashed line includes a spacing (e.g., unmarked component) between the first component and a second component (e.g., second marked component) of the dashed line.

In some examples, the system(s) may determine information associated with one or more components of the dashed line, including both marked components and unmarked components. For instance, the information may include, but not be limited to, a location(s) (e.g., a start point location(s), an end point location(s), etc.) of a marked or unmarked component, a length of the marked or unmarked component, a width of the marked component, a number/order of the marked or unmarked component, an intensity associated with the marked or unmarked component, and/or a pose or orientation associated with the marked or unmarked component. In some instances, the system(s) may determine the information based at least on the relationship, the representation, and/or the intensity values in the input data.

In some examples, the system(s) may update the map data to include one or more features and/or labels corresponding to the one or more components of the dashed line. In some examples, the system(s) may replace, update, and/or supplement a previous, single feature/label associated with the dashed line as a whole for one or more respective features/labels for the individual components of the dashed line. That is, since prior algorithms (e.g., deep learning algorithms) detect dashed lines as a single component or feature, the system(s) may update the map data to replace, update, and/or supplement this single component or feature with multiple components or features for the different components (e.g., stripes, dashes, marked portions, unmarked portions, etc.) of the dashed line. In some examples, and as noted above, the input data may include first feature data obtained from the mapping data, and the system(s) may generate second feature data associated with the one or more components of the dashed line (e.g., a new layer associated with the map). In some instances, the second feature data may include the information (e.g., location, width, length, etc.) associated with the one or more components. Additionally, in some examples, the system(s) may cause the mapping data to be updated to include the second feature data. In this way, the individual components of the dashed line, as well as the start and end point locations, may serve as critical clues for localization algorithms, thereby allowing autonomous and/or semi-autonomous vehicles and/or other machines to improve their performance in safety-critical environments.

In some examples, the system(s) may additionally, or alternatively, cause one or more machines to perform one or more operations based on the features associated with the one or more lane line components. For instance, the system(s) may cause a machine to perform localization based at least on updating the mapping data to include the features and/or labels associated with the one or more components of the dashed line. By being able to localize itself with respect to individual components of a dashed line, as opposed to the dashed line as a whole, the machine may more accurately determine its location, pose, etc. in an environment in which the machine may be operating.

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems implementing large language models (LLMs), systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems for performing generative AI operations, systems implemented at least partially using cloud computing resources, and/or other types of systems.

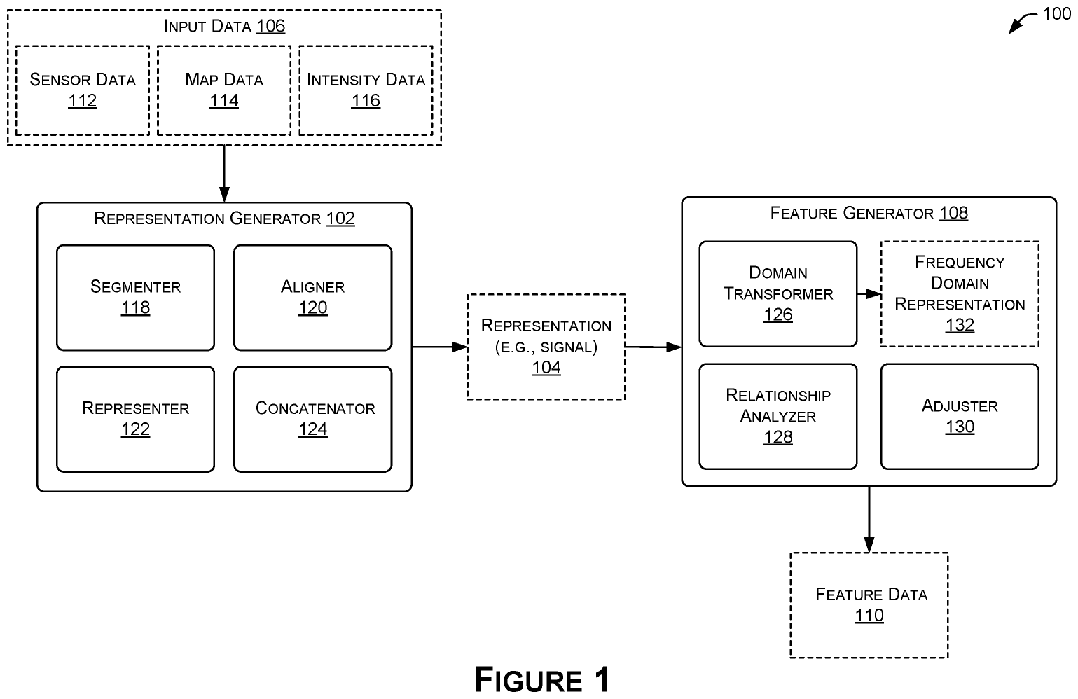

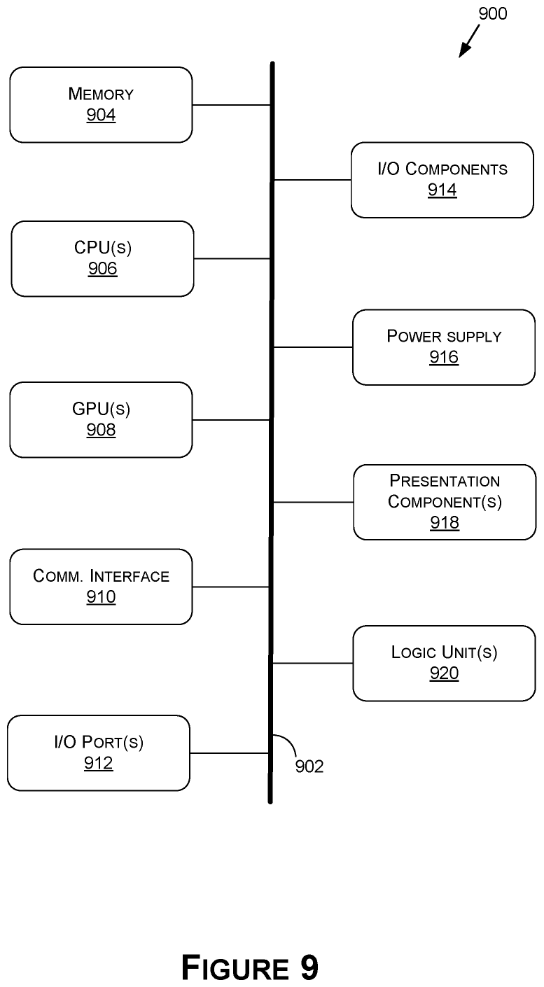

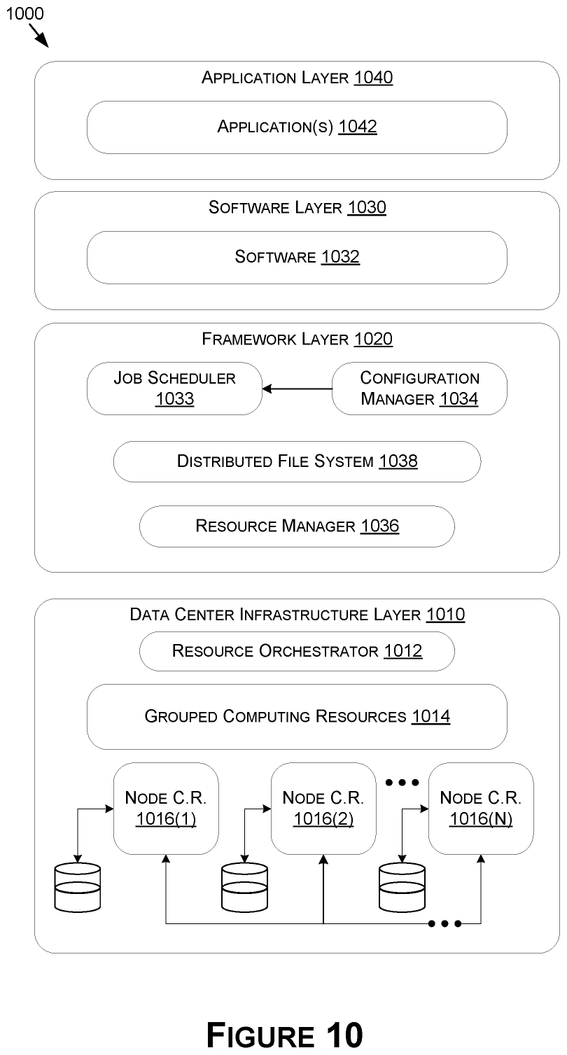

With reference to the accompanying drawings, FIG. 1 is a data flow diagram illustrating an example process 100 of determining feature data associated with dashed line components, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. In some embodiments, the systems, methods, and processes described herein may be executed using similar components, features, and/or functionality to those of example autonomous vehicle 800 of FIGS. 8A-8D, example computing device 900 of FIG. 9, and/or example data center 1000 of FIG. 10.

The process 100 may include a representation generator 102 that outputs a representation 104 (e.g., a representation associated with a dashed line) based at least on input data 106. The process 100 may also include a feature generator 108 that outputs feature data 110 based at least on the representation 104. In some examples, the input data 106 may be a dataset that includes sensor data 112, map data 114, intensity data 116, and/or any other types of data described herein. In examples, the input data 106 may represent a dashed line associated with a drivable surface. In some examples, the input data 106 may include a labeled, dashed line feature(s) and an aerial-view (e.g., birds-eye view, top-down view, etc.) image(s). In some examples, the labeled, dashed line feature(s) and/or the image(s) may be obtained from, or included in, any one of the sensor data 112, the map data 114, or the intensity data 116. For example, the dashed line feature(s) may be obtained from the map data 114 and the image(s) may be an intensity image(s) obtained from the intensity data 116. Such an intensity image(s), in some examples, may be generated from LiDAR data and/or other sensor data, and one or more points or pixels within the intensity image(s) may be associated with one or more intensity values indicative of a strength or amplitude of a reflected laser pulse from a surface at that location in the environment. In such intensity data 116, certain features associated with a road surface, such as a lane line(s), may correspond with higher intensity values, whereas other features associated with the road surface, such as bare asphalt, concrete, etc., may correspond with lower intensity values.

In some examples, the representation generator 102 may generate the representation 104 associated with the dashed line(s) based at least on intensity values associated with points corresponding to the input data 106. That is, based at least on the intensity data 116 of the input data 106, the representation generator 102 may determine the representation 104 associated with the dashed line(s). In some examples, the representation 104 may include a 1D signal that may be plotted with respect to a first axis (e.g., vertical axis) and a second axis (e.g., horizontal axis). For instance, the first axis may correspond with intensity values of the intensity data 116 and the second axis may correspond with point location and/or point distance from an origin. In this way, a data point associated with the representation 104 may be plotted by projecting a point(s) intensity value(s) and location/distance with respect to the first axis and second axis.

In some examples, the representation generator 102 may include a segmenter 118, an aligner 120, a representer 122, and a concatenator 124, which may perform various operations on behalf of the representation generator 102 to generate the representation 104 associated with the dashed line. For instance, the segmenter 118 may perform segmentation on the input data 106 and project bounding shapes along the dashed lane-line, the aligner 120 may align or orient portions of the input data 106 included in the one or more bounding shapes, the representer 122 may determine segmented representation(s) associated with the portions of the dashed line represented in the one or more bounding shapes, and the concatenator 124 may concatenate one or more of the segmented representation(s) to determine the representation 104. In examples, the representation 104 may include one or multiple representations associated with a dashed line, and the representation 104 may correspond with an entire length of the dashed line or a portion/section of the dashed line.

In some examples, the segmenter 118 may segment the input data 106 by determining bounding shapes along the dashed line. For instance, and as illustrated and explained in further detail below with reference to FIG. 4B, the segmenter 118 may project one or more bounding shapes along the dashed line to segment the input data 106 and/or the dashed line into smaller portions of data for easier processing. For instance, the segmenter 118 may determine a first bounding shape along the dashed line, a second, distinguishable bounding shape along the dashed line, and so forth. In this way, the first bounding shape may include a first section of the dashed line, the second bounding shape may include a second section of the dashed line, and so forth.

In some examples, the segmenter 118 may project the bounding shapes onto the input data 106 such that the bounding shapes are non-overlapping (e.g., a first bounding shape is proximate to a second bounding shape, but does not overlap the second bounding shape, and so forth). In other words, the segmenter 118 may determine the bounding shapes such that the first bounding shape includes a first set of points of the input data 106, the second bounding shape includes a second set of points of the input data 106 that are distinguishable from the first set of points, and so forth. Additionally, in some examples, the segmenter 118 may position the one or more bounding shapes along a centerline associated with the dashed line. That is, assuming symmetric bounding shapes, the segmenter 118 may position the bounding shapes such that the dashed line and/or the centerline effectively divides an individual bounding shape into two substantially equivalent sized and/or shaped portions.

In some examples, the segmenter 118 may determine sizes of bounding shapes to use based on the input. For instance, the segmenter 118 may adjust a length of a bounding shape based at least on a magnitude of curvature of a lane line. As an example, in a scenario where the lane line is substantially straight, the segmenter 118 may determine to use a longer bounding shape. However, in a different scenario where the lane line curves or bends (e.g., a corner), the segmenter 118 may determine to use a shorter bounding shape.

In some examples, the aligner 120 may align or orient the segmented input data 106 for analysis by rotating portion(s) of the input data 106 that is included within the one or more bounding shapes. For instance, and as illustrated and explained in further detail below with reference to FIG. 4C, the aligner 120 may, if needed, rotate the segmented input data 106 to align the data horizontally. Additionally, or alternatively, the aligner 120 may determine to refrain from rotating or otherwise modifying the segmented input data (e.g., if a dashed line is substantially horizontal in the input data 106). In some examples, the aligner 120 may align the segmented input data 106 by projecting points within the bounding shape to a horizontal or vertical frame.

In some examples, the aligner 120 may rotate different portions of the input data 106 and/or the different bounding shapes by different magnitudes of rotation. For instance, the aligner 120 may rotate a first bounding shape and its points therein by a first number of degrees while rotating a second bounding shape and its respective points by a second number of degrees. In examples, the differences in rotation may be based on an angle of the dashed line with respect to a horizontal axis associated with the input data 106. After the segmented data and/or the bounding shapes are aligned, the points within the bounding shapes may be logically partitioned into different rows and columns.

In some examples, the representer 122 may determine, based at least on the aligned, segmented data, a segmented representation(s) (e.g., 1D signal(s)) associated with the portions of the dashed line represented in the one or more bounding shapes. For instance, for the points included in a first bounding shape of the one or more bounding shapes, the representer 122 may determine a first intensity value (e.g., first overall intensity value) based at least on one or more of the intensity values within a first column of the points within the bounding shape. Additionally, the representer 122 may determine a second intensity value (e.g., second overall intensity value) based at least on one or more of the intensity values included in a second column of the points within the bounding shape. That is, the first intensity value and the second intensity value may be a sum or an average of all the intensity values included in the first column and the second column, respectively. In examples, the representer 122 may cause the first intensity value to be plotted as a first data point of the segmented representation, cause the second intensity value to be plotted as a second data point of the segmented representation, and so forth. In some examples, the representer 122 may compute a low overall intensity value for a column that does not include any points having intensity values corresponding with marked components of a dashed line (e.g., includes only unmarked components), and compute a higher overall intensity value for a column that includes points having intensity values corresponding with at least some marked components of the dashed line.

In some examples, the concatenator 124 may concatenate one or more of the segmented representation(s) generated by the representer 122. That is, because the segmented representation(s) are generated based on a segment or portion of the dashed line, to determine a full representation of the entire line, or simply a representation of a larger portion/segment of the line, the concatenator 124 may concatenate one or more of the segmented representations of the dashed line. In some examples, the concatenator 124 may concatenate the segmented representations of the dashed line based at least on point position/distance. For instance, the concatenator 124 may concatenate or otherwise piece together two segmented representations by determining that an ending point position/distance of a first segmented representation is proximate a starting point position/distance of a second segmented representation.

In some examples, the feature generator 108 may output the feature data 110 based at least on the representation 104. In some examples, the feature generator 108 may include a domain transformer 126, a relationship analyzer 128, and an adjuster 130, which may perform various operations on behalf of the feature generator 108 to output the feature data 110 associated with one or more components of a dashed line. For instance, the domain transformer 126 may apply a Fast Fourier Transform (FFT) to the representation 104 to determine a frequency domain representation 132 associated with the dashed line, the relationship analyzer 128 may analyze the representation 104 and/or the frequency domain representation 132 to determine relationship(s) (e.g., periodic patterns) across different portions of the dashed line, and the adjuster 130 may adjust a location(s) associated with a component(s) of the dashed line to determine a final location(s) of the component(s) that are to be added to the map data 114. In this, way, the feature generator 108 may output the feature data 110, which may correspond to a component of a dashed line. In examples, the feature data 110 may be added to the map data 114 to improve localization of a machine that relies upon the map data 114.

In some examples, the domain transformer 126 may apply the FFT to the representation 104 to generate the frequency domain representation 132. That is, the domain transformer 126 may, in some instances, transform the representation 104 from its original domain to a frequency domain. The FFT analysis may allow the feature generator 108 to compute a frequency associated with the representation 104 and/or a period associated with the frequency. In some instances, the domain transformer 126 may be referred to as a Fast Fourier Transformer when executing a FFT to convert the signal to the frequency domain.

Using the period and/or the frequency, the relationship analyzer 128 may, in some examples, be able to determine distances between dashed line components, a length of a marked component of the line, a length of an unmarked component of the line, as well as other relationships and periodic patterns between different portions of the dashed line. In some instances, the relationship analyzer 128 may determine these relationships based at least on the representation 104. Additionally, or alternatively, the relationship analyzer 128 may determine these relationships based at least on the frequency domain representation 132.

In some examples, the relationship analyzer 128 may determine relationships between different portions or sections of the dashed line to determine where marked components and unmarked components of the dashed line are located. For instance, the relationship analyzer 128 may determine, based at least on the representation 104, that a first portion of the dashed line is associated with one or more first intensity values while a second portion of the dashed line is associated with one or more second intensity values. The relationship analyzer 128 may further determine that the one or more first intensity values are greater than the one or more second intensity values. Based at least on this information, the relationship analyzer 128 may determine that the first portion of the dashed line includes a first component (e.g., first marked component) and the second portion of the dashed line includes a spacing (e.g., unmarked component) between the first component and a second component (e.g., second marked component) of the dashed line.

In some examples, the adjuster 130 may adjust the location(s) associated with the component(s) of the dashed line to determine the final location(s) of the component(s) in the map data 114. In some examples, the adjuster 130 may use the representation 104, the intensity data 116, and/or the frequency domain representation 132 to determine the final location(s) of the lane line component(s) that are to be added to the map data 114. In some examples, the adjuster 130 may determine coordinates indicating the location where a label corresponding to a lane line component is to be added to the map data 114. Additionally, in some examples, the adjuster 130 may determine a pose or orientation for the lane line component with respect to the map data 114.

In some examples, the feature data 110 may include information associated with one or more components of the dashed line, including both marked components and unmarked components. For instance, the information may include, but not be limited to, a location(s) (e.g., a start point location(s), an end point location(s), etc.) of a marked or unmarked component, a length of the marked or unmarked component, a width of the marked component, a number/order of the marked or unmarked component, an intensity associated with the marked or unmarked component, and a pose or orientation associated with the marked or unmarked component. In some examples, the feature data 110 associated with a dashed line component may be added to the map data 114 for use by a machine.

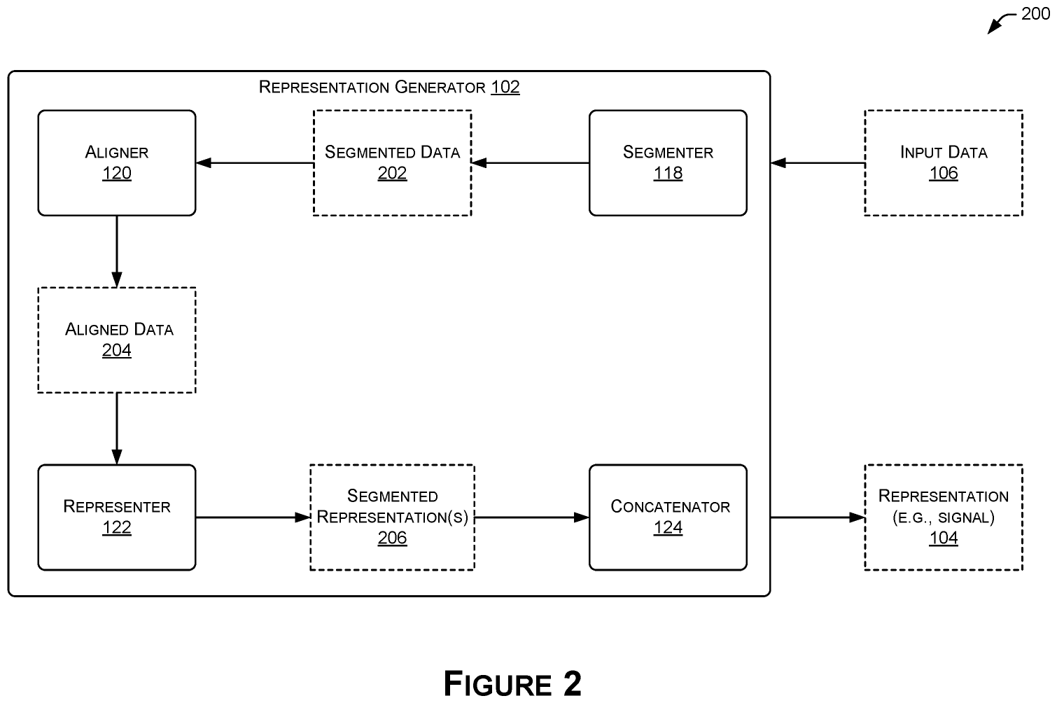

FIG. 2 is a data flow diagram illustrating an example process 200 of determining a representation 104 associated with a dashed line, in accordance with some embodiments of the present disclosure. In some examples, the segmenter 118 may output segmented data 202 based at least on the input data 106 by determining bounding shapes along the dashed line. For instance, and as illustrated and explained in further detail below with reference to FIG. 4B, the segmented data 202 may include one or more bounding shapes projected along the dashed line to segment the input data 106 and/or the dashed line into smaller portions of data for easier processing. For instance, the segmented data 202 may include a first bounding shape along the dashed line, a second, distinguishable bounding shape along the dashed line, and so forth. In this way, the first bounding shape may include a first section of the dashed line, the second bounding shape may include a second section of the dashed line, and so forth.

In some examples, the bounding shapes of the segmented data 202 may be projected onto the input data 106 such that the bounding shapes are non-overlapping (e.g., a first bounding shape is proximate to a second bounding shape, but does not overlap the second bounding shape, and so forth). In other words, within the segmented data 202 the first bounding shape may include a first set of points of the input data 106, the second bounding shape may include a second set of points of the input data 106 that are distinguishable from the first set of points, and so forth. Additionally, in some examples, the one or more bounding shapes included in the segmented data 202 may be positioned along a centerline associated with the dashed line. That is, assuming symmetric bounding shapes, the bounding shapes of the segmented data 202 may be positioned such that the dashed line and/or the centerline effectively divides an individual bounding shape into two substantially equivalent sized and/or shaped portions.

In some examples, the aligner 120 may obtain the segmented data 202 and determine aligned data 204 by rotating or otherwise manipulating portion(s) of the input data 106 that is included within the one or more bounding shapes of the segmented data 202. For instance, the segmented data 202 may be rotated by the aligner 120 to generate the aligned data 204. In some examples, the aligned data 204 may include a portion of the input data 106 that is inside of a bounding shape and that has been aligned horizontally such that a centerline of the dashed line is oriented substantially horizontally.

In some examples, the representer 122 may obtain the aligned data 204 and determine a segmented representation(s) 206 (e.g., one or more segmented representations). In some examples, the segmented representation(s) 206 may include a 1D signal(s) associated with the portions of the dashed line represented in the one or more bounding shapes of the aligned data 204. That is, a segmented representation may include a representation associated with the portion of the dashed line that is inside of the horizontally oriented bounding shape.

In some examples, the concatenator 124 may concatenate one or more of the segmented representation(s) 206 generated by the representer 122 to generate the representation 104. That is, because the segmented representation(s) 206 are generated based on a segment or portion of the dashed line, to determine a full representation of the entire line, or even a representation of a larger portion/segment of the line, the concatenator 124 may concatenate one or more of the segmented representation(s) 206 associated with the dashed line. In some examples, the concatenator 124 may concatenate the segmented representation(s) 206 of the dashed line based at least on point position/distance. For instance, the concatenator 124 may concatenate or otherwise piece together two segmented representation(s) 206 by determining that an ending point position/distance of a first segmented representation is proximate a starting point position/distance of a second segmented representation.

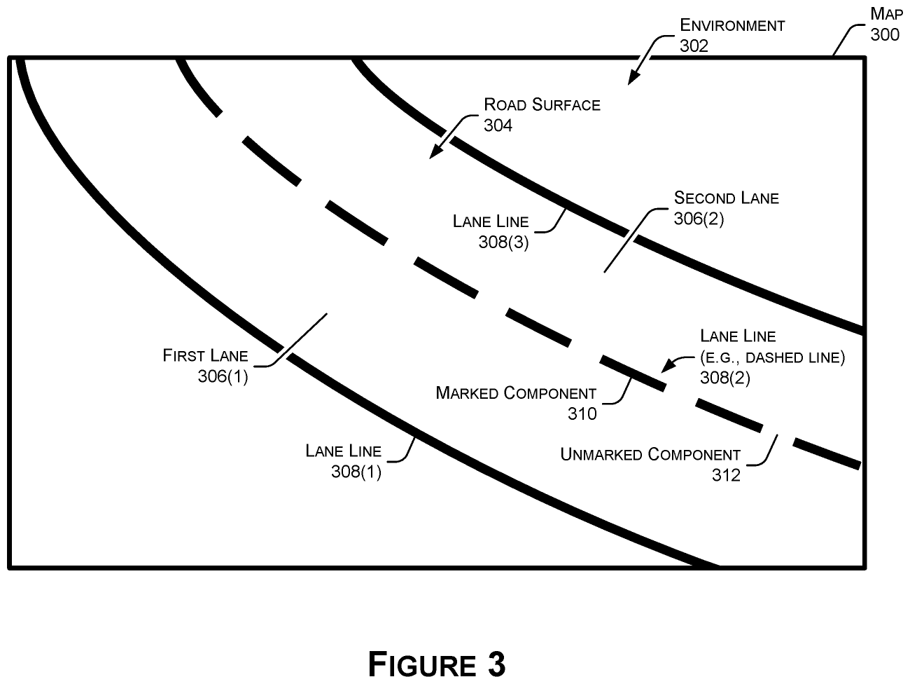

For an example, FIG. 3 illustrates an example map 300 including various lane line features, in accordance with some embodiments of the present disclosure. The map 300 illustrated in FIG. 3 may correspond to a portion of the map data 114 described above and herein. The map 300, as well as the map data 114, may be generated based at least on the sensor data 112, in accordance with some embodiments of the present disclosure. In some examples, the map 300 may be associated with a specific area within an environment 302. Among other things, the environment 302 may include a road surface 304. In some examples, the road surface may include a first lane 306(1) and a second lane 306(2) that are defined by one or more lane lines. For instance, the first lane 306(1) is disposed between the lane line 308(1) and the lane line 308(2), while the second lane 306(2) is disposed between the lane line 308(2) and the lane line 308(3). In examples, the lane line 308(2) may be referred to as a lane divider line.

In the map 300 of FIG. 3, the lane lines 308(1) and 308(3) correspond with solid lanes lines, and the lane line 308(2) corresponds with—and is representative of—a dashed line, in accordance with some embodiments of the present disclosure. The lane line 308(2), as well as a “dashed line” as described herein, may include one or more marked components (e.g., stripes, dashes, elements, painted portions, etc.), such as the marked component 310. Additionally, the lane line 308(2) may include one or more unmarked components (e.g., spaces, breaks, unpainted portions, etc.), such as the unmarked component 312. The lane lines 308(1)-308(3) may hereinafter be referred to collectively as “lane lines 308.” In some examples, the lane lines 308 of the map 300 may be referred to herein as “features” of the map 300, and these features may be labeled in the map 300 and/or the map data 114 for use by one or more system(s) associated with a machine.

FIGS. 4A-4E collectively illustrate example detail associated with determining a representation associated with a dashed line, in accordance with some embodiments of the present disclosure. For instance, FIGS. 4A-4E may correspond with, and illustrate additional detail of, aspects of the processes 100 and 200 described above with reference to FIGS. 1 and 2. Although the examples shown and described with respect to FIGS. 4A-4E are explained in the context of dashed lane line, the techniques of this disclosure are equally applicable to other dashed or broken road surface markings as well (e.g., road surface markings which may not specifically be lane lines).

In examples, the intensity data 116 illustrated in FIG. 4A may be generated using LiDAR data, in accordance with some embodiments of the present disclosure. In the example of FIG. 4A, the intensity data 116 may include one or more points having respective intensities (e.g., intensity values) for respective locations in the environment. The intensity data 116 may correspond to a same part of the environment 302 as the map 300 illustrated in the example of FIG. 3. For example, first points associated with first intensities 402 may be associated with the lane lines 308, while second points associated with second intensities 404 and third points associated with third intensities 406 may be associated with features other than the lane lines 308. For instance, the third points associated with third intensities 406 may be associated with the road surface 304 and the second points associated with the second intensities 404 may be associated a non-road surface, in at least some instances. In some examples, the first intensities 402 associated with the first points may be within a first intensity range, the second intensities 404 associated with the second points may be within a second intensity range, and the third intensities 406 associated with the third points may be within a third intensity range. Because of this, the intensity data 116 may depict the first points associated with the first intensities 402 including a color or shade that differs from the second points associated with the second intensities 404, and even further differs from the third points associated with the third intensities 406.

As shown in FIG. 4A, because of the differences in intensities associated with the different features in the environment depicted in the intensity data 116, different components associated with the lane line 308(2) may be associated with different intensities. For instance, the marked components of the lane line 308(2), such as the marked component 310, may be associated with the first intensities 402 and, therefore, may be depicted in a first color or shade, while the unmarked components of the lane line 308(2) such as the unmarked component 312, may be associated with the third intensities 406 and, therefore, may be depicted in a second color or shade that differs from the marked components.

With reference to FIG. 4B, one or more bounding shapes 408 may be determined based at least on the intensity data 116. For instance, the segmenter 118 may determine the bounding shapes 408 by projecting the bounding shapes along the lane line 308(2). In some examples, the bounding shapes 408 may effectively segment the intensity data 116 and/or the lane line 308(2) into smaller portions of data. As illustrated in FIG. 4B, the bounding shapes 408 may be positioned such that they are aligned along a centerline of the lane line 308(2). For instance, and as illustrated in FIG. 4B, the bounding shapes 408 are positioned such that the lane line 308(2) effectively divides individual ones of the bounding shapes 408 into two substantially equivalent sized and/or shaped portions. Additionally, the bounding shapes 408 may, in some examples, be determined such that they are non-overlapping. For instance, the bounding shape 408(1) does not overlap or otherwise contain any points that are also contained in its neighboring bounding shapes 408. In some examples, sizes and/or shapes of bounding shapes 408 may vary (e.g., based on the input) and the sizes and/or shapes of the bounding shapes illustrated in FIG. 4B should not be construed as limiting. For instance, a length of the bounding shapes 408 may be varied based at least on a magnitude of curvature of the lane line 308(2).

As illustrated in FIG. 4B, the bounding shapes 408 may correspond to different portions or sections of the lane line 308(2). For instance, the bounding shape 408(1) includes points corresponding to a first specific portion/section of the lane line 308(2) that includes a marked component and two portions of two distinct unmarked components of the lane line 308(2). In contrast, the bounding shape 408(2) includes points corresponding to a second specific portion/section of the lane line 308(2) that includes a portion of a marked component and a portion of an unmarked portion of the lane line 308(2).

With reference to FIG. 4C, the aligner 120 may obtain the segmented data 202 and determine the aligned data 204 by rotating the segmented data 202 to align, horizontally, the marked component 310 and/or a centerline associated with the lane line 308(2). In some examples, the segmented data 202 may include the bounding shape 408(1) and the points the bounding shape 408(1) includes. The aligned data 204 may also include the bounding shape 408(1) and the points the bounding shape 408(1) includes. Those points, as shown in FIG. 4C, may correspond with the marked component 310 and the unmarked components 312(1) and 312(2) of the lane line 308(2).

With reference to FIG. 4D, the representer 122 may obtain the aligned data 204 and determine the segmented representation 206 associated with the portion of the lane line included in the bounding shape 408(1). In examples, the segmented representation 206 may comprise a 1D signal that is plotted on a graph having vertical and horizontal axis. For instance, the graph may include a vertical, intensity axis 410 and a horizontal, point position axis 412. In some examples, the data points along the segmented representation 206 may be determined (e.g., plotted) by the representer 122 based at least on point position and point intensity. As a first example, the representer 122 may perform a summation of all intensity values associated with points contained in a vertical column or slice within the bounding shape. For instance, a point(s) associated with the marked component 310 may be assigned a greater intensity value than a point(s) associated with the unmarked components 312(1) and 312(2). As such, for a vertical column/slice of the points within the bounding shape 408(1), the representer 122 may sum the intensity values of the points in that column/slice and plot the sum as a data point in the segmented representation 206 with respect to the intensity axis 410 (corresponding to the value of the sum) and the point position axis 412 (corresponding to the position of the column/vertical slice). As a second example, and in addition to, or alternatively from, the summation method described above, the representer 122 may average the intensity values of the points in a column/vertical slice, and plot the average value for the segmented representation. As yet another example, the representer 122 may plot point intensities for those points that are located within a threshold distance of the centerline of the lane line (e.g., within 10 points of the centerline, within 20 points of the centerline, etc.), as opposed to using all the points in the bounding shape 408(1). As will be further explained below with reference to FIG. 4E, the middle portion of the segmented representation 206 associated with a high intensity with respect to the intensity axis 410 may correspond with the marked component 310, whereas the outer portions of the segmented representation 206 associated with a lower intensity with respect tot eh intensity axis 410 may correspond with the unmarked components 312(1) and 312(2).

With reference to FIG. 4E, the concatenator 124 may obtain the segmented representation 206 and determine the representation 104, which may also be referred to herein as a “concatenated representation.” In examples, the concatenator 124 may concatenate one or more of the segmented representation(s) to generate the representation 104. In some examples, the representation 104 may correspond to an entire portion of the dash line, or a section of the dash line. In some examples, the concatenator 124 may concatenate the segmented representations of the dashed line based at least on point position/distance. For instance, the concatenator 124 may concatenate or otherwise piece together the segmented representation 206 with another, similar segmented representation by determining that an ending point position/distance of the segmented representation 206 is proximate a starting point position/distance of the other segmented representation, and so forth.

In some examples, the representation 104 may be plotted with respect to the intensity axis 410 and the point position axis 412. In examples, various portions of the representation 104 may be indicative of information and relationships associated with the dashed line the representation 104 is associated with. For instance, the first portion 414 of the representation 104 may correspond to a marked component of the dashed line, such as the marked component 310. Additionally, the second portion 416 of the representation 104 may correspond to an unmarked component of the dashed line, such as one of the unmarked components 312(1) or 312(2).

Additionally, in some examples, the representation 104 may indicate inconsistencies and/or irregularities in patterns of the dashed line. For instance, the third portion 418 of the representation 104 may correspond to an unmarked component of the dashed line, however, this unmarked component (e.g., a spacing) is significantly larger/longer than other unmarked components indicated by other portions of the representation 104, such as the second portion 416. However, the representation 104 allows these irregularities and inconsistencies to be identified so that a map may be updated with appropriate feature data and/or labels for these inconsistent or irregular dashed line components.

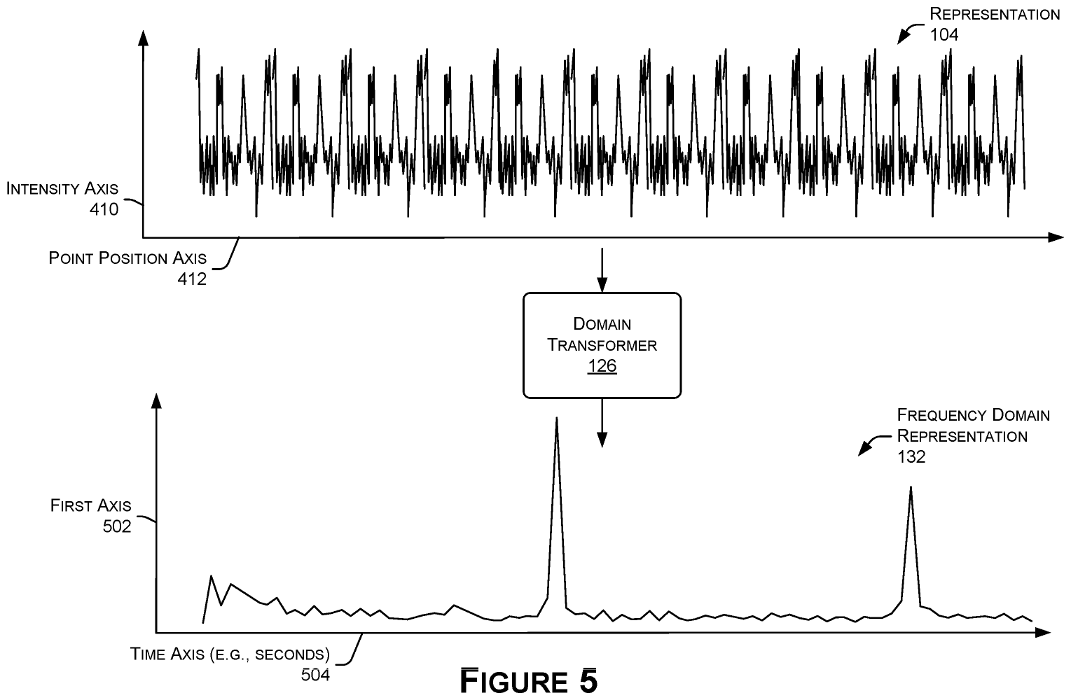

FIG. 5 illustrates an example Fast Fourier Transform analysis of the representation 104 associated with the dashed line, in accordance with some embodiments of the present disclosure. For instance, the domain transformer 126 may obtain the representation 104 and process the representation 104 using a Fast Fourier Transform to determine the frequency domain representation 132. The frequency domain representation 132 may be plotted on the graph with respect to a first axis 502 and a time axis 504, which may be in units of seconds. The FFT analysis may allow a frequency associated with the representation 104 and/or a period associated with the frequency to be more easily determined. In some examples, various information associated with the dashed line and/or its components may be determined based at least on the period and/or the frequency from the frequency domain representation 132. For instance, distances between dashed line components may be determined, a length of a marked component of the line may be determined, a length of an unmarked component of the line may be determined, as well as other relationships and periodic patterns between different portions of the dashed line.

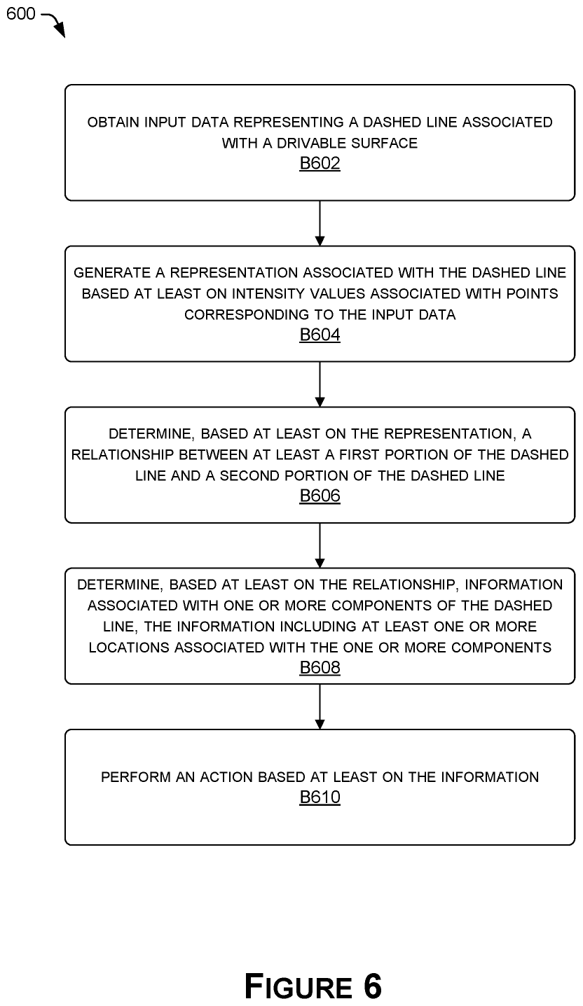

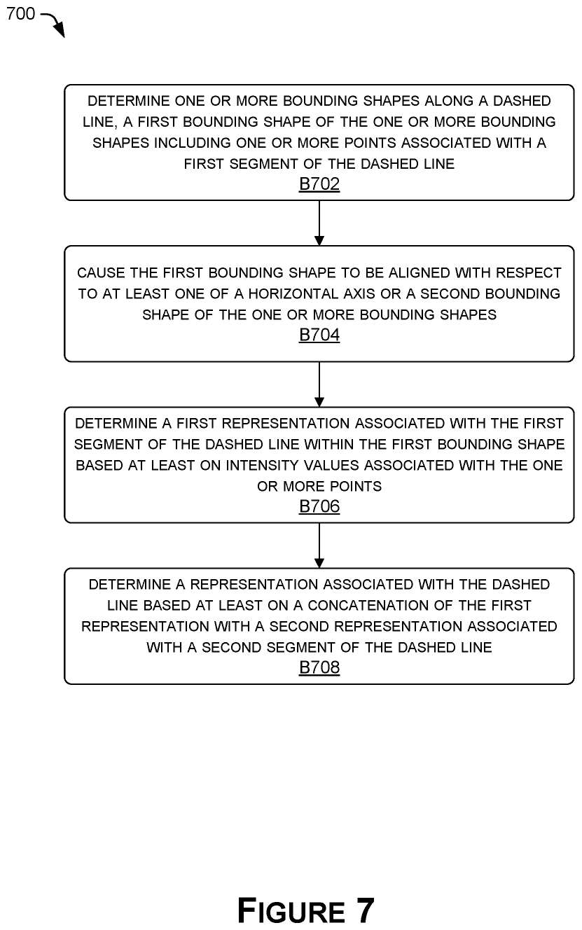

Now referring to FIGS. 6 and 7, each block of methods 600 and 700, described herein, comprises a computing process that may be performed using any combination of hardware, firmware, and/or software. For instance, various functions may be carried out by a processor executing instructions stored in memory. The methods may also be embodied as computer-usable instructions stored on computer storage media. The methods may be provided by a standalone application, a service or hosted service (standalone or in combination with another hosted service), or a plug-in to another product, to name a few. In addition, methods 600 and 700 are described, by way of example, with respect to FIG. 1. However, these methods may additionally or alternatively be executed by any one system, or any combination of systems, including, but not limited to, those described herein.

FIG. 6 is a flowchart illustrating an example method 600 for determining information (e.g., locations, sizes, patterns, etc.) associated with components of a dashed line, in accordance with some embodiments of the present disclosure. The method 600, at block B602, may include obtaining input data representing a dashed line associated with a drivable surface. For instance, the representation generator 102 may obtain the input data 106 representing the dashed line associated with the drivable surface. In some examples, the input data may include a labeled, dashed line feature and an aerial-view (e.g., birds-eye view, top-down view, etc.) image. In some examples, the dashed line feature and/or the image may be determined or otherwise obtained from mapping data. In some examples, the image may be an intensity image generated from LiDAR data, where one or more points or pixels within the image may be associated with one or more intensity values indicative of a strength or amplitude of a reflected laser pulse from a surface at that location in the environment.

The method 600, at block B604, may include generating a representation associated with the dashed line based at least on intensity values associated with points corresponding to the input data. For instance, the representation generator 102 may generate the representation 104 associated with the dashed line based at least on the intensity values associated with the points corresponding to the input data 106. In some examples, the representation may include a 1D signal that may be plotted with respect to a first axis (e.g., vertical axis) and a second axis (e.g., horizontal axis). For instance, the first axis may correspond with intensity values and the second axis may correspond with point location and/or point distance from an origin.

The method 600, at block B606, may include determining, based at least on the representation, a relationship between at least a first portion of the dashed line and a second portion of the dashed line. For instance, the relationship analyzer 128 may determine the relationship between the first portion of the dashed line and the second portion of the dashed line based at least on the representation 104. In some examples, the relationship may be determined based at least on performing a Fast Fourier Transform analysis to transform the representation of the dashed line from a first domain to a frequency domain. In some examples, the relationship may be indicative of periodic patterns across different portions of the dashed line, including relationships and patterns associated with both marked components and unmarked components of the dashed line.

The method 600, at block B608, may include determining, based at least on the relationship, information associated with one or more components of the dashed line, the information including at least one or more locations associated with the one or more components. For instance, the feature generator 108 may determine the information associated with the one or more components of the dashed line based at least on the relationship. In some examples, the one or more locations may include a start point location(s), an end point location(s), etc. associated with a marked or unmarked component of the dashed line. In addition to the one or more locations, the information may also include a length of the marked or unmarked component, a width of the marked component, a number/order of the marked or unmarked component, an intensity associated with the marked or unmarked component, a pose or orientation associated with the marked or unmarked component, and/or the like. In some instances, the information may be determined based at least on the relationship, the representation, and/or the intensity values in the input data.

The method 600, at block B610, may include performing an action based at least on the information. For instance, the feature generator 108 may generate the feature data 110 including some or all of the information. Additionally, or alternatively, the action may include updating the map data 114 with a label and/or the feature data 110 corresponding to the one or more components of the dashed line. Additionally, or alternatively, the action may include optimizing a perception system (e.g., one or more perception system models) associated with a machine based at least in part on the information. Additionally, or alternatively, the action may include causing one or more machines to perform one or more operations based on the information. For instance, a machine (e.g., autonomous vehicle) may perform localization based at least on updating the map data to include the features and/or labels associated with the one or more components of the dashed line.

FIG. 7 is a flowchart illustrating an example method 700 for determining a representation associated with a dashed line, in accordance with some embodiments of the present disclosure. The method 700, at block B702, may include determining one or more bounding shapes along a dashed line, a first bounding shape of the one or more bounding shapes including one or more points associated with a first segment of the dashed line. For instance, the segmenter 118 of the representation generator 102 may determine the one or more bounding shapes along the dashed line. In some examples, the bounding shapes may be projected onto the dashed line such that the bounding shapes are non-overlapping (e.g., a first bounding shape is proximate to a second bounding shape, but does not overlap the second bounding shape, and so forth). Additionally, in some examples, the one or more bounding shapes may be positioned along a centerline of the dashed line. That is, the dashed line and/or a centerline associated with the dashed line may divide the bounding shape into two substantially equivalent sized and/or shaped portions.

The method 700, at block B704, may include causing the first bounding shape to be aligned with respect to at least one of a horizontal axis or a second bounding shape of the one or more bounding shapes. For instance, the aligner 120 of the representation generator 102 may cause the first bounding shape to be aligned with respect to the horizontal axis or the second bounding shape. In some examples, the aligner 120 may rotate the first bounding shape and/or the points included in the first bounding shape such that a centerline associated with the dashed line is oriented horizontally.

The method 700, at block B706, may include determining a first representation associated with the first segment of the dashed line within the first bounding shape based at least on intensity values associated with the one or more points. For instance, the representer 122 of the representation generator 102 may determine the first representation associated with the first segment of the dashed line within the first bounding shape (e.g., the aligned first bounding shape). In some examples, the first representation may include a 1D signal that may be plotted with respect to a first axis (e.g., vertical axis) and a second axis (e.g., horizontal axis). For instance, the first axis may correspond with intensity values and the second axis may correspond with point location and/or point distance from an origin. In examples, the first representation may be a first “segmented representation,” as used herein.

The method 700, at block B708, may include determining a representation associated with the dashed line based at least on a concatenation of the first representation with a second representation associated with a second segment of the dashed line. For instance, the concatenator 124 of the representation generator 102 may determine the representation 104 associated with the dashed line based at least on the concatenation of the first representation with the second representation. That is, the concatenator 124 may concatenate a first segmented representation of the dashed line with a second segmented representation of the dashed line to determine the representation.

### Example Autonomous Vehicle

FIG. 8A is an illustration of an example autonomous vehicle 800, in accordance with some embodiments of the present disclosure. The autonomous vehicle 800 (alternatively referred to herein as the “vehicle 800”) may include, without limitation, a passenger vehicle, such as a car, a truck, a bus, a first responder vehicle, a shuttle, an electric or motorized bicycle, a motorcycle, a fire truck, a police vehicle, an ambulance, a boat, a construction vehicle, an underwater craft, a robotic vehicle, a drone, an airplane, a vehicle coupled to a trailer (e.g., a semi-tractor-trailer truck used for hauling cargo), and/or another type of vehicle (e.g., that is unmanned and/or that accommodates one or more passengers). Autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The vehicle 800 may be capable of functionality in accordance with one or more of Level 3-Level 5 of the autonomous driving levels. The vehicle 800 may be capable of functionality in accordance with one or more of Level 1-Level 5 of the autonomous driving levels. For example, the vehicle 800 may be capable of driver assistance (Level 1), partial automation (Level 2), conditional automation (Level 3), high automation (Level 4), and/or full automation (Level 5), depending on the embodiment. The term “autonomous,” as used herein, may include any and/or all types of autonomy for the vehicle 800 or other machine, such as being fully autonomous, being highly autonomous, being conditionally autonomous, being partially autonomous, providing assistive autonomy, being semi-autonomous, being primarily autonomous, or other designation.

The vehicle 800 may include components such as a chassis, a vehicle body, wheels (e.g., 2, 4, 6, 8, 18, etc.), tires, axles, and other components of a vehicle. The vehicle 800 may include a propulsion system 850, such as an internal combustion engine, hybrid electric power plant, an all-electric engine, and/or another propulsion system type. The propulsion system 850 may be connected to a drive train of the vehicle 800, which may include a transmission, to enable the propulsion of the vehicle 800. The propulsion system 850 may be controlled in response to receiving signals from the throttle/accelerator 852.

A steering system 854, which may include a steering wheel, may be used to steer the vehicle 800 (e.g., along a desired path or route) when the propulsion system 850 is operating (e.g., when the vehicle is in motion). The steering system 854 may receive signals from a steering actuator 856. The steering wheel may be optional for full automation (Level 5) functionality.

The brake sensor system 846 may be used to operate the vehicle brakes in response to receiving signals from the brake actuators 848 and/or brake sensors.

Controller(s) 836, which may include one or more system on chips (SoCs) 804 (FIG. 8C) and/or GPU(s), may provide signals (e.g., representative of commands) to one or more components and/or systems of the vehicle 800. For example, the controller(s) may send signals to operate the vehicle brakes via one or more brake actuators 848, to operate the steering system 854 via one or more steering actuators 856, to operate the propulsion system 850 via one or more throttle/accelerators 852. The controller(s) 836 may include one or more onboard (e.g., integrated) computing devices (e.g., supercomputers) that process sensor signals, and output operation commands (e.g., signals representing commands) to enable autonomous driving and/or to assist a human driver in driving the vehicle 800. The controller(s) 836 may include a first controller 836 for autonomous driving functions, a second controller 836 for functional safety functions, a third controller 836 for artificial intelligence functionality (e.g., computer vision), a fourth controller 836 for infotainment functionality, a fifth controller 836 for redundancy in emergency conditions, and/or other controllers. In some examples, a single controller 836 may handle two or more of the above functionalities, two or more controllers 836 may handle a single functionality, and/or any combination thereof.

The controller(s) 836 may provide the signals for controlling one or more components and/or systems of the vehicle 800 in response to sensor data received from one or more sensors (e.g., sensor inputs). The sensor data may be received from, for example and without limitation, global navigation satellite systems (“GNSS”) sensor(s) 858 (e.g., Global Positioning System sensor(s)), RADAR sensor(s) 860, ultrasonic sensor(s) 862, LIDAR sensor(s) 864, inertial measurement unit (IMU) sensor(s) 866 (e.g., accelerometer(s), gyroscope(s), magnetic compass(es), magnetometer(s), etc.), microphone(s) 896, stereo camera(s) 868, wide-view camera(s) 870 (e.g., fisheye cameras), infrared camera(s) 872, surround camera(s) 874 (e.g., 360 degree cameras), long-range and/or mid-range camera(s) 898, speed sensor(s) 844 (e.g., for measuring the speed of the vehicle 800), vibration sensor(s) 842, steering sensor(s) 840, brake sensor(s) (e.g., as part of the brake sensor system 846), and/or other sensor types.

One or more of the controller(s) 836 may receive inputs (e.g., represented by input data) from an instrument cluster 832 of the vehicle 800 and provide outputs (e.g., represented by output data, display data, etc.) via a human-machine interface (HMI) display 834, an audible annunciator, a loudspeaker, and/or via other components of the vehicle 800. The outputs may include information such as vehicle velocity, speed, time, map data (e.g., the High Definition (“HD”) map 822 of FIG. 8C), location data (e.g., the vehicle's 800 location, such as on a map), direction, location of other vehicles (e.g., an occupancy grid), information about objects and status of objects as perceived by the controller(s) 836, etc. For example, the HMI display 834 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The vehicle 800 further includes a network interface 824 which may use one or more wireless antenna(s) 826 and/or modem(s) to communicate over one or more networks. For example, the network interface 824 may be capable of communication over Long-Term Evolution (“LTE”), Wideband Code Division Multiple Access (“WCDMA”), Universal Mobile Telecommunications System (“UMTS”), Global System for Mobile communication (“GSM”), IMT-CDMA Multi-Carrier (“CDMA2000”), etc. The wireless antenna(s) 826 may also enable communication between objects in the environment (e.g., vehicles, mobile devices, etc.), using local area network(s), such as Bluetooth, Bluetooth Low Energy (“LE”), Z-Wave, ZigBee, etc., and/or low power wide-area network(s) (“LPWANs”), such as LoRaWAN, SigFox, etc.

FIG. 8B is an example of camera locations and fields of view for the example autonomous vehicle 800 of FIG. 8A, in accordance with some embodiments of the present disclosure. The cameras and respective fields of view are one example embodiment and are not intended to be limiting. For example, additional and/or alternative cameras may be included and/or the cameras may be located at different locations on the vehicle 800.

The camera types for the cameras may include, but are not limited to, digital cameras that may be adapted for use with the components and/or systems of the vehicle 800. The camera(s) may operate at automotive safety integrity level (ASIL) B and/or at another ASIL. The camera types may be capable of any image capture rate, such as 60 frames per second (fps), 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

In some examples, one or more of the camera(s) may be used to perform advanced driver assistance systems (ADAS) functions (e.g., as part of a redundant or fail-safe design). For example, a Multi-Function Mono Camera may be installed to provide functions including lane departure warning, traffic sign assist and intelligent headlamp control. One or more of the camera(s) (e.g., all of the cameras) may record and provide image data (e.g., video) simultaneously.

One or more of the cameras may be mounted in a mounting assembly, such as a custom designed (three dimensional (“3D”) printed) assembly, in order to cut out stray light and reflections from within the car (e.g., reflections from the dashboard reflected in the windshield mirrors) which may interfere with the camera's image data capture abilities. With reference to wing-mirror mounting assemblies, the wing-mirror assemblies may be custom 3D printed so that the camera mounting plate matches the shape of the wing-mirror. In some examples, the camera(s) may be integrated into the wing-mirror. For side-view cameras, the camera(s) may also be integrated within the four pillars at each corner of the cabin.

Cameras with a field of view that include portions of the environment in front of the vehicle 800 (e.g., front-facing cameras) may be used for surround view, to help identify forward facing paths and obstacles, as well aid in, with the help of one or more controllers 836 and/or control SoCs, providing information critical to generating an occupancy grid and/or determining the preferred vehicle paths. Front-facing cameras may be used to perform many of the same ADAS functions as LIDAR, including emergency braking, pedestrian detection, and collision avoidance. Front-facing cameras may also be used for ADAS functions and systems including Lane Departure Warnings (“LDW”), Autonomous Cruise Control (“ACC”), and/or other functions such as traffic sign recognition.

A variety of cameras may be used in a front-facing configuration, including, for example, a monocular camera platform that includes a complementary metal oxide semiconductor (“CMOS”) color imager. Another example may be a wide-view camera(s) 870 that may be used to perceive objects coming into view from the periphery (e.g., pedestrians, crossing traffic or bicycles). Although only one wide-view camera is illustrated in FIG. 8B, there may be any number (including zero) of wide-view cameras 870 on the vehicle 800. In addition, any number of long-range camera(s) 898 (e.g., a long-view stereo camera pair) may be used for depth-based object detection, especially for objects for which a neural network has not yet been trained. The long-range camera(s) 898 may also be used for object detection and classification, as well as basic object tracking.

Any number of stereo cameras 868 may also be included in a front-facing configuration. In at least one embodiment, one or more of stereo camera(s) 868 may include an integrated control unit comprising a scalable processing unit, which may provide a programmable logic (“FPGA”) and a multi-core micro-processor with an integrated Controller Area Network (“CAN”) or Ethernet interface on a single chip. Such a unit may be used to generate a 3D map of the vehicle's environment, including a distance estimate for all the points in the image. An alternative stereo camera(s) 868 may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 868 may be used in addition to, or alternatively from, those described herein.

Cameras with a field of view that include portions of the environment to the side of the vehicle 800 (e.g., side-view cameras) may be used for surround view, providing information used to create and update the occupancy grid, as well as to generate side impact collision warnings. For example, surround camera(s) 874 (e.g., four surround cameras 874 as illustrated in FIG. 8B) may be positioned to on the vehicle 800. The surround camera(s) 874 may include wide-view camera(s) 870, fisheye camera(s), 360 degree camera(s), and/or the like. Four example, four fisheye cameras may be positioned on the vehicle's front, rear, and sides. In an alternative arrangement, the vehicle may use three surround camera(s) 874 (e.g., left, right, and rear), and may leverage one or more other camera(s) (e.g., a forward-facing camera) as a fourth surround view camera.

Cameras with a field of view that include portions of the environment to the rear of the vehicle 800 (e.g., rear-view cameras) may be used for park assistance, surround view, rear collision warnings, and creating and updating the occupancy grid. A wide variety of cameras may be used including, but not limited to, cameras that are also suitable as a front-facing camera(s) (e.g., long-range and/or mid-range camera(s) 898, stereo camera(s) 868), infrared camera(s) 872, etc.), as described herein.

FIG. 8C is a block diagram of an example system architecture for the example autonomous vehicle 800 of FIG. 8A, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

Each of the components, features, and systems of the vehicle 800 in FIG. 8C are illustrated as being connected via bus 802. The bus 802 may include a Controller Area Network (CAN) data interface (alternatively referred to herein as a “CAN bus”). A CAN may be a network inside the vehicle 800 used to aid in control of various features and functionality of the vehicle 800, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant.

Although the bus 802 is described herein as being a CAN bus, this is not intended to be limiting. For example, in addition to, or alternatively from, the CAN bus, FlexRay and/or Ethernet may be used. Additionally, although a single line is used to represent the bus 802, this is not intended to be limiting. For example, there may be any number of busses 802, which may include one or more CAN busses, one or more FlexRay busses, one or more Ethernet busses, and/or one or more other types of busses using a different protocol. In some examples, two or more busses 802 may be used to perform different functions, and/or may be used for redundancy. For example, a first bus 802 may be used for collision avoidance functionality and a second bus 802 may be used for actuation control. In any example, each bus 802 may communicate with any of the components of the vehicle 800, and two or more busses 802 may communicate with the same components. In some examples, each SoC 804, each controller 836, and/or each computer within the vehicle may have access to the same input data (e.g., inputs from sensors of the vehicle 800), and may be connected to a common bus, such the CAN bus.

The vehicle 800 may include one or more controller(s) 836, such as those described herein with respect to FIG. 8A. The controller(s) 836 may be used for a variety of functions. The controller(s) 836 may be coupled to any of the various other components and systems of the vehicle 800, and may be used for control of the vehicle 800, artificial intelligence of the vehicle 800, infotainment for the vehicle 800, and/or the like.

The vehicle 800 may include a system(s) on a chip (SoC) 804. The SoC 804 may include CPU(s) 806, GPU(s) 808, processor(s) 810, cache(s) 812, accelerator(s) 814, data store(s) 816, and/or other components and features not illustrated. The SoC(s) 804 may be used to control the vehicle 800 in a variety of platforms and systems. For example, the SoC(s) 804 may be combined in a system (e.g., the system of the vehicle 800) with an HD map 822 which may obtain map refreshes and/or updates via a network interface 824 from one or more servers (e.g., server(s) 878 of FIG. 8D).

The CPU(s) 806 may include a CPU cluster or CPU complex (alternatively referred to herein as a “CCPLEX”). The CPU(s) 806 may include multiple cores and/or L2 caches. For example, in some embodiments, the CPU(s) 806 may include eight cores in a coherent multi-processor configuration. In some embodiments, the CPU(s) 806 may include four dual-core clusters where each cluster has a dedicated L2 cache (e.g., a 2 MB L2 cache). The CPU(s) 806 (e.g., the CCPLEX) may be configured to support simultaneous cluster operation enabling any combination of the clusters of the CPU(s) 806 to be active at any given time.

The CPU(s) 806 may implement power management capabilities that include one or more of the following features: individual hardware blocks may be clock-gated automatically when idle to save dynamic power; each core clock may be gated when the core is not actively executing instructions due to execution of WFI/WFE instructions; each core may be independently power-gated; each core cluster may be independently clock-gated when all cores are clock-gated or power-gated; and/or each core cluster may be independently power-gated when all cores are power-gated. The CPU(s) 806 may further implement an enhanced algorithm for managing power states, where allowed power states and expected wakeup times are specified, and the hardware/microcode determines the best power state to enter for the core, cluster, and CCPLEX. The processing cores may support simplified power state entry sequences in software with the work offloaded to microcode.

The GPU(s) 808 may include an integrated GPU (alternatively referred to herein as an “iGPU”). The GPU(s) 808 may be programmable and may be efficient for parallel workloads. The GPU(s) 808, in some examples, may use an enhanced tensor instruction set. The GPU(s) 808 may include one or more streaming microprocessors, where each streaming microprocessor may include an L1 cache (e.g., an L1 cache with at least 96 KB storage capacity), and two or more of the streaming microprocessors may share an L2 cache (e.g., an L2 cache with a 512 KB storage capacity). In some embodiments, the GPU(s) 808 may include at least eight streaming microprocessors. The GPU(s) 808 may use compute application programming interface(s) (API(s)). In addition, the GPU(s) 808 may use one or more parallel computing platforms and/or programming models (e.g., NVIDIA's CUDA).

The GPU(s) 808 may be power-optimized for best performance in automotive and embedded use cases. For example, the GPU(s) 808 may be fabricated on a Fin field-effect transistor (FinFET). However, this is not intended to be limiting and the GPU(s) 808 may be fabricated using other semiconductor manufacturing processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an L0 instruction cache, a warp scheduler, a dispatch unit, and/or a 64 KB register file. In addition, the streaming microprocessors may include independent parallel integer and floating-point data paths to provide for efficient execution of workloads with a mix of computation and addressing calculations. The streaming microprocessors may include independent thread scheduling capability to enable finer-grain synchronization and cooperation between parallel threads. The streaming microprocessors may include a combined L1 data cache and shared memory unit in order to improve performance while simplifying programming.

The GPU(s) 808 may include a high bandwidth memory (HBM) and/or a 16 GB HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 808 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 808 to access the CPU(s) 806 page tables directly. In such examples, when the GPU(s) 808 memory management unit (MMU) experiences a miss, an address translation request may be transmitted to the CPU(s) 806. In response, the CPU(s) 806 may look in its page tables for the virtual-to-physical mapping for the address and transmits the translation back to the GPU(s) 808. As such, unified memory technology may allow a single unified virtual address space for memory of both the CPU(s) 806 and the GPU(s) 808, thereby simplifying the GPU(s) 808 programming and porting of applications to the GPU(s) 808.

In addition, the GPU(s) 808 may include an access counter that may keep track of the frequency of access of the GPU(s) 808 to memory of other processors. The access counter may help ensure that memory pages are moved to the physical memory of the processor that is accessing the pages most frequently.

The SoC(s) 804 may include any number of cache(s) 812, including those described herein. For example, the cache(s) 812 may include an L3 cache that is available to both the CPU(s) 806 and the GPU(s) 808 (e.g., that is connected both the CPU(s) 806 and the GPU(s) 808). The cache(s) 812 may include a write-back cache that may keep track of states of lines, such as by using a cache coherence protocol (e.g., MEI, MESI, MSI, etc.). The L3 cache may include 4 MB or more, depending on the embodiment, although smaller cache sizes may be used.

The SoC(s) 804 may include an arithmetic logic unit(s) (ALU(s)) which may be leveraged in performing processing with respect to any of the variety of tasks or operations of the vehicle 800—such as processing DNNs. In addition, the SoC(s) 804 may include a floating point unit(s) (FPU(s))—or other math coprocessor or numeric coprocessor types—for performing mathematical operations within the system. For example, the SoC(s) 804 may include one or more FPUs integrated as execution units within a CPU(s) 806 and/or GPU(s) 808.

The SoC(s) 804 may include one or more accelerators 814 (e.g., hardware accelerators, software accelerators, or a combination thereof). For example, the SoC(s) 804 may include a hardware acceleration cluster that may include optimized hardware accelerators and/or large on-chip memory. The large on-chip memory (e.g., 4 MB of SRAM), may enable the hardware acceleration cluster to accelerate neural networks and other calculations. The hardware acceleration cluster may be used to complement the GPU(s) 808 and to off-load some of the tasks of the GPU(s) 808 (e.g., to free up more cycles of the GPU(s) 808 for performing other tasks). As an example, the accelerator(s) 814 may be used for targeted workloads (e.g., perception, convolutional neural networks (CNNs), etc.) that are stable enough to be amenable to acceleration. The term “CNN,” as used herein, may include all types of CNNs, including region-based or regional convolutional neural networks (RCNNs) and Fast RCNNs (e.g., as used for object detection).

The accelerator(s) 814 (e.g., the hardware acceleration cluster) may include a deep learning accelerator(s) (DLA). The DLA(s) may include one or more Tensor processing units (TPUs) that may be configured to provide an additional ten trillion operations per second for deep learning applications and inferencing. The TPUs may be accelerators configured to, and optimized for, performing image processing functions (e.g., for CNNs, RCNNs, etc.). The DLA(s) may further be optimized for a specific set of neural network types and floating point operations, as well as inferencing. The design of the DLA(s) may provide more performance per millimeter than a general-purpose GPU, and vastly exceeds the performance of a CPU. The TPU(s) may perform several functions, including a single-instance convolution function, supporting, for example, INT8, INT16, and FP16 data types for both features and weights, as well as post-processor functions.

The DLA(s) may quickly and efficiently execute neural networks, especially CNNs, on processed or unprocessed data for any of a variety of functions, including, for example and without limitation: a CNN for object identification and detection using data from camera sensors; a CNN for distance estimation using data from camera sensors; a CNN for emergency vehicle detection and identification and detection using data from microphones; a CNN for facial recognition and vehicle owner identification using data from camera sensors; and/or a CNN for security and/or safety related events.

The DLA(s) may perform any function of the GPU(s) 808, and by using an inference accelerator, for example, a designer may target either the DLA(s) or the GPU(s) 808 for any function. For example, the designer may focus processing of CNNs and floating point operations on the DLA(s) and leave other functions to the GPU(s) 808 and/or other accelerator(s) 814.

The accelerator(s) 814 (e.g., the hardware acceleration cluster) may include a programmable vision accelerator(s) (PVA), which may alternatively be referred to herein as a computer vision accelerator. The PVA(s) may be designed and configured to accelerate computer vision algorithms for the advanced driver assistance systems (ADAS), autonomous driving, and/or augmented reality (AR) and/or virtual reality (VR) applications. The PVA(s) may provide a balance between performance and flexibility. For example, each PVA(s) may include, for example and without limitation, any number of reduced instruction set computer (RISC) cores, direct memory access (DMA), and/or any number of vector processors.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA may enable components of the PVA(s) to access the system memory independently of the CPU(s) 806. The DMA may support any number of features used to provide optimization to the PVA including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors may be programmable processors that may be designed to efficiently and flexibly execute programming for computer vision algorithms and provide signal processing capabilities. In some examples, the PVA may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA, and may include a vector processing unit (VPU), an instruction cache, and/or vector memory (e.g., VMEM). A VPU core may include a digital signal processor such as, for example, a single instruction, multiple data (SIMD), very long instruction word (VLIW) digital signal processor. The combination of the SIMD and VLIW may enhance throughput and speed.

Each of the vector processors may include an instruction cache and may be coupled to dedicated memory. As a result, in some examples, each of the vector processors may be configured to execute independently of the other vector processors. In other examples, the vector processors that are included in a particular PVA may be configured to employ data parallelism. For example, in some embodiments, the plurality of vector processors included in a single PVA may execute the same computer vision algorithm, but on different regions of an image. In other examples, the vector processors included in a particular PVA may simultaneously execute different computer vision algorithms, on the same image, or even execute different algorithms on sequential images or portions of an image. Among other things, any number of PVAs may be included in the hardware acceleration cluster and any number of vector processors may be included in each of the PVAs. In addition, the PVA(s) may include additional error correcting code (ECC) memory, to enhance overall system safety.

The accelerator(s) 814 (e.g., the hardware acceleration cluster) may include a computer vision network on-chip and SRAM, for providing a high-bandwidth, low latency SRAM for the accelerator(s) 814. In some examples, the on-chip memory may include at least 4 MB SRAM, consisting of, for example and without limitation, eight field-configurable memory blocks, that may be accessible by both the PVA and the DLA. Each pair of memory blocks may include an advanced peripheral bus (APB) interface, configuration circuitry, a controller, and a multiplexer. Any type of memory may be used. The PVA and DLA may access the memory via a backbone that provides the PVA and DLA with high-speed access to memory. The backbone may include a computer vision network on-chip that interconnects the PVA and the DLA to the memory (e.g., using the APB).

The computer vision network on-chip may include an interface that determines, before transmission of any control signal/address/data, that both the PVA and the DLA provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

In some examples, the SoC(s) 804 may include a real-time ray-tracing hardware accelerator, such as described in U.S. patent application Ser. No. 16/101,232, filed on Aug. 10, 2018. The real-time ray-tracing hardware accelerator may be used to quickly and efficiently determine the positions and extents of objects (e.g., within a world model), to generate real-time visualization simulations, for RADAR signal interpretation, for sound propagation synthesis and/or analysis, for simulation of SONAR systems, for general wave propagation simulation, for comparison to LIDAR data for purposes of localization and/or other functions, and/or for other uses. In some embodiments, one or more tree traversal units (TTUs) may be used for executing one or more ray-tracing related operations.

The accelerator(s) 814 (e.g., the hardware accelerator cluster) have a wide array of uses for autonomous driving. The PVA may be a programmable vision accelerator that may be used for key processing stages in ADAS and autonomous vehicles. The PVA's capabilities are a good match for algorithmic domains needing predictable processing, at low power and low latency. In other words, the PVA performs well on semi-dense or dense regular computation, even on small data sets, which need predictable run-times with low latency and low power. Thus, in the context of platforms for autonomous vehicles, the PVAs are designed to run classic computer vision algorithms, as they are efficient at object detection and operating on integer math.

For example, according to one embodiment of the technology, the PVA is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA may perform computer stereo vision function on inputs from two monocular cameras.

In some examples, the PVA may be used to perform dense optical flow. According to process raw RADAR data (e.g., using a 4D Fast Fourier Transform) to provide Processed RADAR. In other examples, the PVA is used for time of flight depth processing, by processing raw time of flight data to provide processed time of flight data, for example.

The DLA may be used to run any type of network to enhance control and driving safety, including for example, a neural network that outputs a measure of confidence for each object detection. Such a confidence value may be interpreted as a probability, or as providing a relative “weight” of each detection compared to other detections. This confidence value enables the system to make further decisions regarding which detections should be considered as true positive detections rather than false positive detections. For example, the system may set a threshold value for the confidence and consider only the detections exceeding the threshold value as true positive detections. In an automatic emergency braking (AEB) system, false positive detections would cause the vehicle to automatically perform emergency braking, which is obviously undesirable. Therefore, only the most confident detections should be considered as triggers for AEB. The DLA may run a neural network for regressing the confidence value. The neural network may take as its input at least some subset of parameters, such as bounding box dimensions, ground plane estimate obtained (e.g. from another subsystem), inertial measurement unit (IMU) sensor 866 output that correlates with the vehicle 800 orientation, distance, 3D location estimates of the object obtained from the neural network and/or other sensors (e.g., LIDAR sensor(s) 864 or RADAR sensor(s) 860), among others.

The SoC(s) 804 may include data store(s) 816 (e.g., memory). The data store(s) 816 may be on-chip memory of the SoC(s) 804, which may store neural networks to be executed on the GPU and/or the DLA. In some examples, the data store(s) 816 may be large enough in capacity to store multiple instances of neural networks for redundancy and safety. The data store(s) 812 may comprise L2 or L3 cache(s) 812. Reference to the data store(s) 816 may include reference to the memory associated with the PVA, DLA, and/or other accelerator(s) 814, as described herein.

The SoC(s) 804 may include one or more processor(s) 810 (e.g., embedded processors). The processor(s) 810 may include a boot and power management processor that may be a dedicated processor and subsystem to handle boot power and management functions and related security enforcement. The boot and power management processor may be a part of the SoC(s) 804 boot sequence and may provide runtime power management services. The boot power and management processor may provide clock and voltage programming, assistance in system low power state transitions, management of SoC(s) 804 thermals and temperature sensors, and/or management of the SoC(s) 804 power states. Each temperature sensor may be implemented as a ring-oscillator whose output frequency is proportional to temperature, and the SoC(s) 804 may use the ring-oscillators to detect temperatures of the CPU(s) 806, GPU(s) 808, and/or accelerator(s) 814. If temperatures are determined to exceed a threshold, the boot and power management processor may enter a temperature fault routine and put the SoC(s) 804 into a lower power state and/or put the vehicle 800 into a chauffeur to safe stop mode (e.g., bring the vehicle 800 to a safe stop).

The processor(s) 810 may further include a set of embedded processors that may serve as an audio processing engine. The audio processing engine may be an audio subsystem that enables full hardware support for multi-channel audio over multiple interfaces, and a broad and flexible range of audio I/O interfaces. In some examples, the audio processing engine is a dedicated processor core with a digital signal processor with dedicated RAM.

The processor(s) 810 may further include an always on processor engine that may provide necessary hardware features to support low power sensor management and wake use cases. The always on processor engine may include a processor core, a tightly coupled RAM, supporting peripherals (e.g., timers and interrupt controllers), various I/O controller peripherals, and routing logic.

The processor(s) 810 may further include a safety cluster engine that includes a dedicated processor subsystem to handle safety management for automotive applications. The safety cluster engine may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations.

The processor(s) 810 may further include a real-time camera engine that may include a dedicated processor subsystem for handling real-time camera management.

The processor(s) 810 may further include a high-dynamic range signal processor that may include an image signal processor that is a hardware engine that is part of the camera processing pipeline.

The processor(s) 810 may include a video image compositor that may be a processing block (e.g., implemented on a microprocessor) that implements video post-processing functions needed by a video playback application to produce the final image for the player window. The video image compositor may perform lens distortion correction on wide-view camera(s) 870, surround camera(s) 874, and/or on in-cabin monitoring camera sensors. In-cabin monitoring camera sensor is preferably monitored by a neural network running on another instance of the Advanced SoC, configured to identify in cabin events and respond accordingly. An in-cabin system may perform lip reading to activate cellular service and place a phone call, dictate emails, change the vehicle's destination, activate or change the vehicle's infotainment system and settings, or provide voice-activated web surfing. Certain functions are available to the driver only when the vehicle is operating in an autonomous mode, and are disabled otherwise.

The video image compositor may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

The video image compositor may also be configured to perform stereo rectification on input stereo lens frames. The video image compositor may further be used for user interface composition when the operating system desktop is in use, and the GPU(s) 808 is not required to continuously render new surfaces. Even when the GPU(s) 808 is powered on and active doing 3D rendering, the video image compositor may be used to offload the GPU(s) 808 to improve performance and responsiveness.

The SoC(s) 804 may further include a mobile industry processor interface (MIPI) camera serial interface for receiving video and input from cameras, a high-speed interface, and/or a video input block that may be used for camera and related pixel input functions. The SoC(s) 804 may further include an input/output controller(s) that may be controlled by software and may be used for receiving I/O signals that are uncommitted to a specific role.

The SoC(s) 804 may further include a broad range of peripheral interfaces to enable communication with peripherals, audio codecs, power management, and/or other devices. The SoC(s) 804 may be used to process data from cameras (e.g., connected over Gigabit Multimedia Serial Link and Ethernet), sensors (e.g., LIDAR sensor(s) 864, RADAR sensor(s) 860, etc. that may be connected over Ethernet), data from bus 802 (e.g., speed of vehicle 800, steering wheel position, etc.), data from GNSS sensor(s) 858 (e.g., connected over Ethernet or CAN bus). The SoC(s) 804 may further include dedicated high-performance mass storage controllers that may include their own DMA engines, and that may be used to free the CPU(s) 806 from routine data management tasks.

The SoC(s) 804 may be an end-to-end platform with a flexible architecture that spans automation levels 3-5, thereby providing a comprehensive functional safety architecture that leverages and makes efficient use of computer vision and ADAS techniques for diversity and redundancy, provides a platform for a flexible, reliable driving software stack, along with deep learning tools. The SoC(s) 804 may be faster, more reliable, and even more energy-efficient and space-efficient than conventional systems. For example, the accelerator(s) 814, when combined with the CPU(s) 806, the GPU(s) 808, and the data store(s) 816, may provide for a fast, efficient platform for level 3-5 autonomous vehicles.

The technology thus provides capabilities and functionality that cannot be achieved by conventional systems. For example, computer vision algorithms may be executed on CPUs, which may be configured using high-level programming language, such as the C programming language, to execute a wide variety of processing algorithms across a wide variety of visual data. However, CPUs are oftentimes unable to meet the performance requirements of many computer vision applications, such as those related to execution time and power consumption, for example. In particular, many CPUs are unable to execute complex object detection algorithms in real-time, which is a requirement of in-vehicle ADAS applications, and a requirement for practical Level 3-5 autonomous vehicles.

In contrast to conventional systems, by providing a CPU complex, GPU complex, and a hardware acceleration cluster, the technology described herein allows for multiple neural networks to be performed simultaneously and/or sequentially, and for the results to be combined together to enable Level 3-5 autonomous driving functionality. For example, a CNN executing on the DLA or dGPU (e.g., the GPU(s) 820) may include a text and word recognition, allowing the supercomputer to read and understand traffic signs, including signs for which the neural network has not been specifically trained. The DLA may further include a neural network that is able to identify, interpret, and provides semantic understanding of the sign, and to pass that semantic understanding to the path planning modules running on the CPU Complex.

As another example, multiple neural networks may be run simultaneously, as is required for Level 3, 4, or 5 driving. For example, a warning sign consisting of “Caution: flashing lights indicate icy conditions,” along with an electric light, may be independently or collectively interpreted by several neural networks. The sign itself may be identified as a traffic sign by a first deployed neural network (e.g., a neural network that has been trained), the text “Flashing lights indicate icy conditions” may be interpreted by a second deployed neural network, which informs the vehicle's path planning software (preferably executing on the CPU Complex) that when flashing lights are detected, icy conditions exist. The flashing light may be identified by operating a third deployed neural network over multiple frames, informing the vehicle's path-planning software of the presence (or absence) of flashing lights. All three neural networks may run simultaneously, such as within the DLA and/or on the GPU(s) 808.

In some examples, a CNN for facial recognition and vehicle owner identification may use data from camera sensors to identify the presence of an authorized driver and/or owner of the vehicle 800. The always on sensor processing engine may be used to unlock the vehicle when the owner approaches the driver door and turn on the lights, and, in security mode, to disable the vehicle when the owner leaves the vehicle. In this way, the SoC(s) 804 provide for security against theft and/or carjacking.

In another example, a CNN for emergency vehicle detection and identification may use data from microphones 896 to detect and identify emergency vehicle sirens. In contrast to conventional systems, that use general classifiers to detect sirens and manually extract features, the SoC(s) 804 use the CNN for classifying environmental and urban sounds, as well as classifying visual data. In a preferred embodiment, the CNN running on the DLA is trained to identify the relative closing speed of the emergency vehicle (e.g., by using the Doppler Effect). The CNN may also be trained to identify emergency vehicles specific to the local area in which the vehicle is operating, as identified by GNSS sensor(s) 858. Thus, for example, when operating in Europe the CNN will seek to detect European sirens, and when in the United States the CNN will seek to identify only North American sirens. Once an emergency vehicle is detected, a control program may be used to execute an emergency vehicle safety routine, slowing the vehicle, pulling over to the side of the road, parking the vehicle, and/or idling the vehicle, with the assistance of ultrasonic sensors 862, until the emergency vehicle(s) passes.

The vehicle may include a CPU(s) 818 (e.g., discrete CPU(s), or dCPU(s)), that may be coupled to the SoC(s) 804 via a high-speed interconnect (e.g., PCIe). The CPU(s) 818 may include an X86 processor, for example. The CPU(s) 818 may be used to perform any of a variety of functions, including arbitrating potentially inconsistent results between ADAS sensors and the SoC(s) 804, and/or monitoring the status and health of the controller(s) 836 and/or infotainment SoC 830, for example.

The vehicle 800 may include a GPU(s) 820 (e.g., discrete GPU(s), or dGPU(s)), that may be coupled to the SoC(s) 804 via a high-speed interconnect (e.g., NVIDIA's NVLINK). The GPU(s) 820 may provide additional artificial intelligence functionality, such as by executing redundant and/or different neural networks, and may be used to train and/or update neural networks based on input (e.g., sensor data) from sensors of the vehicle 800.

The vehicle 800 may further include the network interface 824 which may include one or more wireless antennas 826 (e.g., one or more wireless antennas for different communication protocols, such as a cellular antenna, a Bluetooth antenna, etc.). The network interface 824 may be used to enable wireless connectivity over the Internet with the cloud (e.g., with the server(s) 878 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the vehicle 800 information about vehicles in proximity to the vehicle 800 (e.g., vehicles in front of, on the side of, and/or behind the vehicle 800). This functionality may be part of a cooperative adaptive cruise control functionality of the vehicle 800.

The network interface 824 may include a SoC that provides modulation and demodulation functionality and enables the controller(s) 836 to communicate over wireless networks. The network interface 824 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. The network interface may include wireless functionality for communicating over LTE, WCDMA, UMTS, GSM, CDMA2000, Bluetooth, Bluetooth LE, Wi-Fi, Z-Wave, ZigBee, LoRaWAN, and/or other wireless protocols.

The vehicle 800 may further include data store(s) 828 which may include off-chip (e.g., off the SoC(s) 804) storage. The data store(s) 828 may include one or more storage elements including RAM, SRAM, DRAM, VRAM, Flash, hard disks, and/or other components and/or devices that may store at least one bit of data.

The vehicle 800 may further include GNSS sensor(s) 858. The GNSS sensor(s) 858 (e.g., GPS, assisted GPS sensors, differential GPS (DGPS) sensors, etc.), to assist in mapping, perception, occupancy grid generation, and/or path planning functions. Any number of GNSS sensor(s) 858 may be used, including, for example and without limitation, a GPS using a USB connector with an Ethernet to Serial (RS-232) bridge.

The vehicle 800 may further include RADAR sensor(s) 860. The RADAR sensor(s) 860 may be used by the vehicle 800 for long-range vehicle detection, even in darkness and/or severe weather conditions. RADAR functional safety levels may be ASIL B. The RADAR sensor(s) 860 may use the CAN and/or the bus 802 (e.g., to transmit data generated by the RADAR sensor(s) 860) for control and to access object tracking data, with access to Ethernet to access raw data in some examples. A wide variety of RADAR sensor types may be used. For example, and without limitation, the RADAR sensor(s) 860 may be suitable for front, rear, and side RADAR use. In some example, Pulse Doppler RADAR sensor(s) are used.

The RADAR sensor(s) 860 may include different configurations, such as long range with narrow field of view, short range with wide field of view, short range side coverage, etc. In some examples, long-range RADAR may be used for adaptive cruise control functionality. The long-range RADAR systems may provide a broad field of view realized by two or more independent scans, such as within a 250 m range. The RADAR sensor(s) 860 may help in distinguishing between static and moving objects, and may be used by ADAS systems for emergency brake assist and forward collision warning. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the vehicle's 800 surroundings at higher speeds with minimal interference from traffic in adjacent lanes. The other two antennae may expand the field of view, making it possible to quickly detect vehicles entering or leaving the vehicle's 800 lane.

Mid-range RADAR systems may include, as an example, a range of up to 860 m (front) or 80 m (rear), and a field of view of up to 42 degrees (front) or 850 degrees (rear). Short-range RADAR systems may include, without limitation, RADAR sensors designed to be installed at both ends of the rear bumper. When installed at both ends of the rear bumper, such a RADAR sensor systems may create two beams that constantly monitor the blind spot in the rear and next to the vehicle.

Short-range RADAR systems may be used in an ADAS system for blind spot detection and/or lane change assist.

The vehicle 800 may further include ultrasonic sensor(s) 862. The ultrasonic sensor(s) 862, which may be positioned at the front, back, and/or the sides of the vehicle 800, may be used for park assist and/or to create and update an occupancy grid. A wide variety of ultrasonic sensor(s) 862 may be used, and different ultrasonic sensor(s) 862 may be used for different ranges of detection (e.g., 2.5 m, 4 m). The ultrasonic sensor(s) 862 may operate at functional safety levels of ASIL B.

The vehicle 800 may include LIDAR sensor(s) 864. The LIDAR sensor(s) 864 may be used for object and pedestrian detection, emergency braking, collision avoidance, and/or other functions. The LIDAR sensor(s) 864 may be functional safety level ASIL B. In some examples, the vehicle 800 may include multiple LIDAR sensors 864 (e.g., two, four, six, etc.) that may use Ethernet (e.g., to provide data to a Gigabit Ethernet switch).

In some examples, the LIDAR sensor(s) 864 may be capable of providing a list of objects and their distances for a 360-degree field of view. Commercially available LIDAR sensor(s) 864 may have an advertised range of approximately 800 m, with an accuracy of 2 cm-3 cm, and with support for a 800 Mbps Ethernet connection, for example. In some examples, one or more non-protruding LIDAR sensors 864 may be used. In such examples, the LIDAR sensor(s) 864 may be implemented as a small device that may be embedded into the front, rear, sides, and/or corners of the vehicle 800. The LIDAR sensor(s) 864, in such examples, may provide up to a 120-degree horizontal and 35-degree vertical field-of-view, with a 200 m range even for low-reflectivity objects. Front-mounted LIDAR sensor(s) 864 may be configured for a horizontal field of view between 45 degrees and 135 degrees.

In some examples, LIDAR technologies, such as 3D flash LIDAR, may also be used. 3D Flash LIDAR uses a flash of a laser as a transmission source, to illuminate vehicle surroundings up to approximately 200 m. A flash LIDAR unit includes a receptor, which records the laser pulse transit time and the reflected light on each pixel, which in turn corresponds to the range from the vehicle to the objects. Flash LIDAR may allow for highly accurate and distortion-free images of the surroundings to be generated with every laser flash. In some examples, four flash LIDAR sensors may be deployed, one at each side of the vehicle 800. Available 3D flash LIDAR systems include a solid-state 3D staring array LIDAR camera with no moving parts other than a fan (e.g., a non-scanning LIDAR device). The flash LIDAR device may use a 5 nanosecond class I (eye-safe) laser pulse per frame and may capture the reflected laser light in the form of 3D range point clouds and co-registered intensity data. By using flash LIDAR, and because flash LIDAR is a solid-state device with no moving parts, the LIDAR sensor(s) 864 may be less susceptible to motion blur, vibration, and/or shock.

The vehicle may further include IMU sensor(s) 866. The IMU sensor(s) 866 may be located at a center of the rear axle of the vehicle 800, in some examples. The IMU sensor(s) 866 may include, for example and without limitation, an accelerometer(s), a magnetometer(s), a gyroscope(s), a magnetic compass(es), and/or other sensor types. In some examples, such as in six-axis applications, the IMU sensor(s) 866 may include accelerometers and gyroscopes, while in nine-axis applications, the IMU sensor(s) 866 may include accelerometers, gyroscopes, and magnetometers.

In some embodiments, the IMU sensor(s) 866 may be implemented as a miniature, high performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 866 may enable the vehicle 800 to estimate heading without requiring input from a magnetic sensor by directly observing and correlating the changes in velocity from GPS to the IMU sensor(s) 866. In some examples, the IMU sensor(s) 866 and the GNSS sensor(s) 858 may be combined in a single integrated unit.

The vehicle may include microphone(s) 896 placed in and/or around the vehicle 800. The microphone(s) 896 may be used for emergency vehicle detection and identification, among other things.

The vehicle may further include any number of camera types, including stereo camera(s) 868, wide-view camera(s) 870, infrared camera(s) 872, surround camera(s) 874, long-range and/or mid-range camera(s) 898, and/or other camera types. The cameras may be used to capture image data around an entire periphery of the vehicle 800. The types of cameras used depends on the embodiments and requirements for the vehicle 800, and any combination of camera types may be used to provide the necessary coverage around the vehicle 800. In addition, the number of cameras may differ depending on the embodiment. For example, the vehicle may include six cameras, seven cameras, ten cameras, twelve cameras, and/or another number of cameras. The cameras may support, as an example and without limitation, Gigabit Multimedia Serial Link (GMSL) and/or Gigabit Ethernet. Each of the camera(s) is described with more detail herein with respect to FIG. 8A and FIG. 8B.

The vehicle 800 may further include vibration sensor(s) 842. The vibration sensor(s) 842 may measure vibrations of components of the vehicle, such as the axle(s). For example, changes in vibrations may indicate a change in road surfaces. In another example, when two or more vibration sensors 842 are used, the differences between the vibrations may be used to determine friction or slippage of the road surface (e.g., when the difference in vibration is between a power-driven axle and a freely rotating axle).

The vehicle 800 may include an ADAS system 838. The ADAS system 838 may include a SoC, in some examples. The ADAS system 838 may include autonomous/adaptive/automatic cruise control (ACC), cooperative adaptive cruise control (CACC), forward crash warning (FCW), automatic emergency braking (AEB), lane departure warnings (LDW), lane keep assist (LKA), blind spot warning (BSW), rear cross-traffic warning (RCTW), collision warning systems (CWS), lane centering (LC), and/or other features and functionality.

The ACC systems may use RADAR sensor(s) 860, LIDAR sensor(s) 864, and/or a camera(s). The ACC systems may include longitudinal ACC and/or lateral ACC. Longitudinal ACC monitors and controls the distance to the vehicle immediately ahead of the vehicle 800 and automatically adjust the vehicle speed to maintain a safe distance from vehicles ahead. Lateral ACC performs distance keeping, and advises the vehicle 800 to change lanes when necessary. Lateral ACC is related to other ADAS applications such as LCA and CWS.

CACC uses information from other vehicles that may be received via the network interface 824 and/or the wireless antenna(s) 826 from other vehicles via a wireless link, or indirectly, over a network connection (e.g., over the Internet). Direct links may be provided by a vehicle-to-vehicle (V2V) communication link, while indirect links may be infrastructure-to-vehicle (12V) communication link. In general, the V2V communication concept provides information about the immediately preceding vehicles (e.g., vehicles immediately ahead of and in the same lane as the vehicle 800), while the I2V communication concept provides information about traffic further ahead. CACC systems may include either or both I2V and V2V information sources. Given the information of the vehicles ahead of the vehicle 800, CACC may be more reliable and it has potential to improve traffic flow smoothness and reduce congestion on the road.

FCW systems are designed to alert the driver to a hazard, so that the driver may take corrective action. FCW systems use a front-facing camera and/or RADAR sensor(s) 860, coupled to a dedicated processor, DSP, FPGA, and/or ASIC, that is electrically coupled to driver feedback, such as a display, speaker, and/or vibrating component. FCW systems may provide a warning, such as in the form of a sound, visual warning, vibration and/or a quick brake pulse.

AEB systems detect an impending forward collision with another vehicle or other object, and may automatically apply the brakes if the driver does not take corrective action within a specified time or distance parameter. AEB systems may use front-facing camera(s) and/or RADAR sensor(s) 860, coupled to a dedicated processor, DSP, FPGA, and/or ASIC. When the AEB system detects a hazard, it typically first alerts the driver to take corrective action to avoid the collision and, if the driver does not take corrective action, the AEB system may automatically apply the brakes in an effort to prevent, or at least mitigate, the impact of the predicted collision. AEB systems, may include techniques such as dynamic brake support and/or crash imminent braking.

LDW systems provide visual, audible, and/or tactile warnings, such as steering wheel or seat vibrations, to alert the driver when the vehicle 800 crosses lane markings. A LDW system does not activate when the driver indicates an intentional lane departure, by activating a turn signal. LDW systems may use front-side facing cameras, coupled to a dedicated processor, DSP, FPGA, and/or ASIC, that is electrically coupled to driver feedback, such as a display, speaker, and/or vibrating component.

LKA systems are a variation of LDW systems. LKA systems provide steering input or braking to correct the vehicle 800 if the vehicle 800 starts to exit the lane.

BSW systems detects and warn the driver of vehicles in an automobile's blind spot. BSW systems may provide a visual, audible, and/or tactile alert to indicate that merging or changing lanes is unsafe. The system may provide an additional warning when the driver uses a turn signal. BSW systems may use rear-side facing camera(s) and/or RADAR sensor(s) 860, coupled to a dedicated processor, DSP, FPGA, and/or ASIC, that is electrically coupled to driver feedback, such as a display, speaker, and/or vibrating component.

RCTW systems may provide visual, audible, and/or tactile notification when an object is detected outside the rear-camera range when the vehicle 800 is backing up. Some RCTW systems include AEB to ensure that the vehicle brakes are applied to avoid a crash. RCTW systems may use one or more rear-facing RADAR sensor(s) 860, coupled to a dedicated processor, DSP, FPGA, and/or ASIC, that is electrically coupled to driver feedback, such as a display, speaker, and/or vibrating component.

Conventional ADAS systems may be prone to false positive results which may be annoying and distracting to a driver, but typically are not catastrophic, because the ADAS systems alert the driver and allow the driver to decide whether a safety condition truly exists and act accordingly. However, in an autonomous vehicle 800, the vehicle 800 itself must, in the case of conflicting results, decide whether to heed the result from a primary computer or a secondary computer (e.g., a first controller 836 or a second controller 836). For example, in some embodiments, the ADAS system 838 may be a backup and/or secondary computer for providing perception information to a backup computer rationality module. The backup computer rationality monitor may run a redundant diverse software on hardware components to detect faults in perception and dynamic driving tasks. Outputs from the ADAS system 838 may be provided to a supervisory MCU. If outputs from the primary computer and the secondary computer conflict, the supervisory MCU must determine how to reconcile the conflict to ensure safe operation.

In some examples, the primary computer may be configured to provide the supervisory MCU with a confidence score, indicating the primary computer's confidence in the chosen result. If the confidence score exceeds a threshold, the supervisory MCU may follow the primary computer's direction, regardless of whether the secondary computer provides a conflicting or inconsistent result. Where the confidence score does not meet the threshold, and where the primary and secondary computer indicate different results (e.g., the conflict), the supervisory MCU may arbitrate between the computers to determine the appropriate outcome.

The supervisory MCU may be configured to run a neural network(s) that is trained and configured to determine, based on outputs from the primary computer and the secondary computer, conditions under which the secondary computer provides false alarms. Thus, the neural network(s) in the supervisory MCU may learn when the secondary computer's output may be trusted, and when it cannot. For example, when the secondary computer is a RADAR-based FCW system, a neural network(s) in the supervisory MCU may learn when the FCW system is identifying metallic objects that are not, in fact, hazards, such as a drainage grate or manhole cover that triggers an alarm. Similarly, when the secondary computer is a camera-based LDW system, a neural network in the supervisory MCU may learn to override the LDW when bicyclists or pedestrians are present and a lane departure is, in fact, the safest maneuver. In embodiments that include a neural network(s) running on the supervisory MCU, the supervisory MCU may include at least one of a DLA or GPU suitable for running the neural network(s) with associated memory. In preferred embodiments, the supervisory MCU may comprise and/or be included as a component of the SoC(s) 804.

In other examples, ADAS system 838 may include a secondary computer that performs ADAS functionality using traditional rules of computer vision. As such, the secondary computer may use classic computer vision rules (if-then), and the presence of a neural network(s) in the supervisory MCU may improve reliability, safety and performance. For example, the diverse implementation and intentional non-identity makes the overall system more fault-tolerant, especially to faults caused by software (or software-hardware interface) functionality. For example, if there is a software bug or error in the software running on the primary computer, and the non-identical software code running on the secondary computer provides the same overall result, the supervisory MCU may have greater confidence that the overall result is correct, and the bug in software or hardware on primary computer is not causing material error.

In some examples, the output of the ADAS system 838 may be fed into the primary computer's perception block and/or the primary computer's dynamic driving task block. For example, if the ADAS system 838 indicates a forward crash warning due to an object immediately ahead, the perception block may use this information when identifying objects. In other examples, the secondary computer may have its own neural network which is trained and thus reduces the risk of false positives, as described herein.

The vehicle 800 may further include the infotainment SoC 830 (e.g., an in-vehicle infotainment system (IVI)). Although illustrated and described as a SoC, the infotainment system may not be a SoC, and may include two or more discrete components. The infotainment SoC 830 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., LTE, Wi-Fi, etc.), and/or information services (e.g., navigation systems, rear-parking assistance, a radio data system, vehicle related information such as fuel level, total distance covered, brake fuel level, oil level, door open/close, air filter information, etc.) to the vehicle 800. For example, the infotainment SoC 830 may radios, disk players, navigation systems, video players, USB and Bluetooth connectivity, carputers, in-car entertainment, Wi-Fi, steering wheel audio controls, hands free voice control, a heads-up display (HUD), an HMI display 834, a telematics device, a control panel (e.g., for controlling and/or interacting with various components, features, and/or systems), and/or other components. The infotainment SoC 830 may further be used to provide information (e.g., visual and/or audible) to a user(s) of the vehicle, such as information from the ADAS system 838, autonomous driving information such as planned vehicle maneuvers, trajectories, surrounding environment information (e.g., intersection information, vehicle information, road information, etc.), and/or other information.

The infotainment SoC 830 may include GPU functionality. The infotainment SoC 830 may communicate over the bus 802 (e.g., CAN bus, Ethernet, etc.) with other devices, systems, and/or components of the vehicle 800. In some examples, the infotainment SoC 830 may be coupled to a supervisory MCU such that the GPU of the infotainment system may perform some self-driving functions in the event that the primary controller(s) 836 (e.g., the primary and/or backup computers of the vehicle 800) fail. In such an example, the infotainment SoC 830 may put the vehicle 800 into a chauffeur to safe stop mode, as described herein.

The vehicle 800 may further include an instrument cluster 832 (e.g., a digital dash, an electronic instrument cluster, a digital instrument panel, etc.). The instrument cluster 832 may include a controller and/or supercomputer (e.g., a discrete controller or supercomputer). The instrument cluster 832 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 830 and the instrument cluster 832. In other words, the instrument cluster 832 may be included as part of the infotainment SoC 830, or vice versa.

FIG. 8D is a system diagram for communication between cloud-based server(s) and the example autonomous vehicle 800 of FIG. 8A, in accordance with some embodiments of the present disclosure. The system 876 may include server(s) 878, network(s) 890, and vehicles, including the vehicle 800. The server(s) 878 may include a plurality of GPUs 884(A)-884(H) (collectively referred to herein as GPUs 884), PCIe switches 882(A)-882(H) (collectively referred to herein as PCIe switches 882), and/or CPUs 880(A)-880(B) (collectively referred to herein as CPUs 880). The GPUs 884, the CPUs 880, and the PCIe switches may be interconnected with high-speed interconnects such as, for example and without limitation, NVLink interfaces 888 developed by NVIDIA and/or PCIe connections 886. In some examples, the GPUs 884 are connected via NVLink and/or NVSwitch SoC and the GPUs 884 and the PCIe switches 882 are connected via PCIe interconnects. Although eight GPUs 884, two CPUs 880, and two PCIe switches are illustrated, this is not intended to be limiting. Depending on the embodiment, each of the server(s) 878 may include any number of GPUs 884, CPUs 880, and/or PCIe switches. For example, the server(s) 878 may each include eight, sixteen, thirty-two, and/or more GPUs 884.

The server(s) 878 may receive, over the network(s) 890 and from the vehicles, image data representative of images showing unexpected or changed road conditions, such as recently commenced road-work. The server(s) 878 may transmit, over the network(s) 890 and to the vehicles, neural networks 892, updated neural networks 892, and/or map information 894, including information regarding traffic and road conditions. The updates to the map information 894 may include updates for the HD map 822, such as information regarding construction sites, potholes, detours, flooding, and/or other obstructions. In some examples, the neural networks 892, the updated neural networks 892, and/or the map information 894 may have resulted from new training and/or experiences represented in data received from any number of vehicles in the environment, and/or based on training performed at a datacenter (e.g., using the server(s) 878 and/or other servers).

The server(s) 878 may be used to train machine learning models (e.g., neural networks) based on training data. The training data may be generated by the vehicles, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self-learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the vehicles (e.g., transmitted to the vehicles over the network(s) 890, and/or the machine learning models may be used by the server(s) 878 to remotely monitor the vehicles.

In some examples, the server(s) 878 may receive data from the vehicles and apply the data to up-to-date real-time neural networks for real-time intelligent inferencing. The server(s) 878 may include deep-learning supercomputers and/or dedicated AI computers powered by GPU(s) 884, such as a DGX and DGX Station machines developed by NVIDIA. However, in some examples, the server(s) 878 may include deep learning infrastructure that use only CPU-powered datacenters.

The deep-learning infrastructure of the server(s) 878 may be capable of fast, real-time inferencing, and may use that capability to evaluate and verify the health of the processors, software, and/or associated hardware in the vehicle 800. For example, the deep-learning infrastructure may receive periodic updates from the vehicle 800, such as a sequence of images and/or objects that the vehicle 800 has located in that sequence of images (e.g., via computer vision and/or other machine learning object classification techniques). The deep-learning infrastructure may run its own neural network to identify the objects and compare them with the objects identified by the vehicle 800 and, if the results do not match and the infrastructure concludes that the AI in the vehicle 800 is malfunctioning, the server(s) 878 may transmit a signal to the vehicle 800 instructing a fail-safe computer of the vehicle 800 to assume control, notify the passengers, and complete a safe parking maneuver.

For inferencing, the server(s) 878 may include the GPU(s) 884 and one or more programmable inference accelerators (e.g., NVIDIA's TensorRT). The combination of GPU-powered servers and inference acceleration may make real-time responsiveness possible. In other examples, such as where performance is less critical, servers powered by CPUs, FPGAs, and other processors may be used for inferencing.

### Example Computing Device

FIG. 9 is a block diagram of an example computing device(s) 900 suitable for use in implementing some embodiments of the present disclosure. Computing device 900 may include an interconnect system 902 that directly or indirectly couples the following devices: memory 904, one or more central processing units (CPUs) 906, one or more graphics processing units (GPUs) 908, a communication interface 910, input/output (I/O) ports 912, input/output components 914, a power supply 916, one or more presentation components 918 (e.g., display(s)), and one or more logic units 920. In at least one embodiment, the computing device(s) 900 may comprise one or more virtual machines (VMs), and/or any of the components thereof may comprise virtual components (e.g., virtual hardware components). For non-limiting examples, one or more of the GPUs 908 may comprise one or more vGPUs, one or more of the CPUs 906 may comprise one or more vCPUs, and/or one or more of the logic units 920 may comprise one or more virtual logic units. As such, a computing device(s) 900 may include discrete components (e.g., a full GPU dedicated to the computing device 900), virtual components (e.g., a portion of a GPU dedicated to the computing device 900), or a combination thereof.

Although the various blocks of FIG. 9 are shown as connected via the interconnect system 902 with lines, this is not intended to be limiting and is for clarity only. For example, in some embodiments, a presentation component 918, such as a display device, may be considered an I/O component 914 (e.g., if the display is a touch screen). As another example, the CPUs 906 and/or GPUs 908 may include memory (e.g., the memory 904 may be representative of a storage device in addition to the memory of the GPUs 908, the CPUs 906, and/or other components). In other words, the computing device of FIG. 9 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 9.

The interconnect system 902 may represent one or more links or busses, such as an address bus, a data bus, a control bus, or a combination thereof. The interconnect system 902 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 906 may be directly connected to the memory 904. Further, the CPU 906 may be directly connected to the GPU 908. Where there is direct, or point-to-point connection between components, the interconnect system 902 may include a PCIe link to carry out the connection. In these examples, a PCI bus need not be included in the computing device 900.

The memory 904 may include any of a variety of computer-readable media. The computer-readable media may be any available media that may be accessed by the computing device 900. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 904 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 900. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 906 may be configured to execute at least some of the computer-readable instructions to control one or more components of the computing device 900 to perform one or more of the methods and/or processes described herein. The CPU(s) 906 may each include one or more cores (e.g., one, two, four, eight, twenty-eight, seventy-two, etc.) that are capable of handling a multitude of software threads simultaneously. The CPU(s) 906 may include any type of processor, and may include different types of processors depending on the type of computing device 900 implemented (e.g., processors with fewer cores for mobile devices and processors with more cores for servers). For example, depending on the type of computing device 900, the processor may be an Advanced RISC Machines (ARM) processor implemented using Reduced Instruction Set Computing (RISC) or an x86 processor implemented using Complex Instruction Set Computing (CISC). The computing device 900 may include one or more CPUs 906 in addition to one or more microprocessors or supplementary co-processors, such as math co-processors.

In addition to or alternatively from the CPU(s) 906, the GPU(s) 908 may be configured to execute at least some of the computer-readable instructions to control one or more components of the computing device 900 to perform one or more of the methods and/or processes described herein. One or more of the GPU(s) 908 may be an integrated GPU (e.g., with one or more of the CPU(s) 906 and/or one or more of the GPU(s) 908 may be a discrete GPU. In embodiments, one or more of the GPU(s) 908 may be a coprocessor of one or more of the CPU(s) 906. The GPU(s) 908 may be used by the computing device 900 to render graphics (e.g., 3D graphics) or perform general purpose computations. For example, the GPU(s) 908 may be used for General-Purpose computing on GPUs (GPGPU). The GPU(s) 908 may include hundreds or thousands of cores that are capable of handling hundreds or thousands of software threads simultaneously. The GPU(s) 908 may generate pixel data for output images in response to rendering commands (e.g., rendering commands from the CPU(s) 906 received via a host interface). The GPU(s) 908 may include graphics memory, such as display memory, for storing pixel data or any other suitable data, such as GPGPU data. The display memory may be included as part of the memory 904. The GPU(s) 908 may include two or more GPUs operating in parallel (e.g., via a link). The link may directly connect the GPUs (e.g., using NVLINK) or may connect the GPUs through a switch (e.g., using NVSwitch). When combined together, each GPU 908 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 906 and/or the GPU(s) 908, the logic unit(s) 920 may be configured to execute at least some of the computer-readable instructions to control one or more components of the computing device 900 to perform one or more of the methods and/or processes described herein. In embodiments, the CPU(s) 906, the GPU(s) 908, and/or the logic unit(s) 920 may discretely or jointly perform any combination of the methods, processes and/or portions thereof. One or more of the logic units 920 may be part of and/or integrated in one or more of the CPU(s) 906 and/or the GPU(s) 908 and/or one or more of the logic units 920 may be discrete components or otherwise external to the CPU(s) 906 and/or the GPU(s) 908. In embodiments, one or more of the logic units 920 may be a coprocessor of one or more of the CPU(s) 906 and/or one or more of the GPU(s) 908.

Examples of the logic unit(s) 920 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 910 may include one or more receivers, transmitters, and/or transceivers that enable the computing device 900 to communicate with other computing devices via an electronic communication network, included wired and/or wireless communications. The communication interface 910 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 920 and/or communication interface 910 may include one or more data processing units (DPUs) to transmit data received over a network and/or through interconnect system 902 directly to (e.g., a memory of) one or more GPU(s) 908.

The I/O ports 912 may enable the computing device 900 to be logically coupled to other devices including the I/O components 914, the presentation component(s) 918, and/or other components, some of which may be built in to (e.g., integrated in) the computing device 900. Illustrative I/O components 914 include a microphone, mouse, keyboard, joystick, game pad, game controller, satellite dish, scanner, printer, wireless device, etc. The I/O components 914 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 900. The computing device 900 may be include depth cameras, such as stereoscopic camera systems, infrared camera systems, RGB camera systems, touchscreen technology, and combinations of these, for gesture detection and recognition. Additionally, the computing device 900 may include accelerometers or gyroscopes (e.g., as part of an inertia measurement unit (IMU)) that enable detection of motion. In some examples, the output of the accelerometers or gyroscopes may be used by the computing device 900 to render immersive augmented reality or virtual reality.

The power supply 916 may include a hard-wired power supply, a battery power supply, or a combination thereof. The power supply 916 may provide power to the computing device 900 to enable the components of the computing device 900 to operate.

The presentation component(s) 918 may include a display (e.g., a monitor, a touch screen, a television screen, a heads-up-display (HUD), other display types, or a combination thereof), speakers, and/or other presentation components. The presentation component(s) 918 may receive data from other components (e.g., the GPU(s) 908, the CPU(s) 906, DPUs, etc.), and output the data (e.g., as an image, video, sound, etc.).

### Example Data Center

FIG. 10 illustrates an example data center 1000 that may be used in at least one embodiments of the present disclosure. The data center 1000 may include a data center infrastructure layer 1010, a framework layer 1020, a software layer 1030, and/or an application layer 1040.

As shown in FIG. 10, the data center infrastructure layer 1010 may include a resource orchestrator 1012, grouped computing resources 1014, and node computing resources (“node C.R.s”) 1016(1)-1016(N), where “N” represents any whole, positive integer. In at least one embodiment, node C.R.s 1016(1)-1016(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1016(1)-1016(N) may correspond to a server having one or more of the above-mentioned computing resources. In addition, in some embodiments, the node C.R.s 1016(1)-10161(N) may include one or more virtual components, such as vGPUs, vCPUs, and/or the like, and/or one or more of the node C.R.s 1016(1)-1016(N) may correspond to a virtual machine (VM).

In at least one embodiment, grouped computing resources 1014 may include separate groupings of node C.R.s 1016 housed within one or more racks (not shown), or many racks housed in data centers at various geographical locations (also not shown). Separate groupings of node C.R.s 1016 within grouped computing resources 1014 may include grouped compute, network, memory or storage resources that may be configured or allocated to support one or more workloads. In at least one embodiment, several node C.R.s 1016 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1012 may configure or otherwise control one or more node C.R.s 1016(1)-1016(N) and/or grouped computing resources 1014. In at least one embodiment, resource orchestrator 1012 may include a software design infrastructure (SDI) management entity for the data center 1000. The resource orchestrator 1012 may include hardware, software, or some combination thereof.

In at least one embodiment, as shown in FIG. 10, framework layer 1020 may include a job scheduler 1033, a configuration manager 1034, a resource manager 1036, and/or a distributed file system 1038. The framework layer 1020 may include a framework to support software 1032 of software layer 1030 and/or one or more application(s) 1042 of application layer 1040. The software 1032 or application(s) 1042 may respectively include web-based service software or applications, such as those provided by Amazon Web Services, Google Cloud and Microsoft Azure. The framework layer 1020 may be, but is not limited to, a type of free and open-source software web application framework such as Apache Spark™ (hereinafter “Spark”) that may utilize distributed file system 1038 for large-scale data processing (e.g., “big data”). In at least one embodiment, job scheduler 1033 may include a Spark driver to facilitate scheduling of workloads supported by various layers of data center 1000. The configuration manager 1034 may be capable of configuring different layers such as software layer 1030 and framework layer 1020 including Spark and distributed file system 1038 for supporting large-scale data processing. The resource manager 1036 may be capable of managing clustered or grouped computing resources mapped to or allocated for support of distributed file system 1038 and job scheduler 1033. In at least one embodiment, clustered or grouped computing resources may include grouped computing resource 1014 at data center infrastructure layer 1010. The resource manager 1036 may coordinate with resource orchestrator 1012 to manage these mapped or allocated computing resources.

In at least one embodiment, software 1032 included in software layer 1030 may include software used by at least portions of node C.R.s 1016(1)-1016(N), grouped computing resources 1014, and/or distributed file system 1038 of framework layer 1020. One or more types of software may include, but are not limited to, Internet web page search software, e-mail virus scan software, database software, and streaming video content software.

In at least one embodiment, application(s) 1042 included in application layer 1040 may include one or more types of applications used by at least portions of node C.R.s 1016(1)-1016(N), grouped computing resources 1014, and/or distributed file system 1038 of framework layer 1020. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1034, resource manager 1036, and resource orchestrator 1012 may implement any number and type of self-modifying actions based on any amount and type of data acquired in any technically feasible fashion. Self-modifying actions may relieve a data center operator of data center 1000 from making possibly bad configuration decisions and possibly avoiding underutilized and/or poor performing portions of a data center.

The data center 1000 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1000. In at least one embodiment, trained or deployed machine learning models corresponding to one or more neural networks may be used to infer or predict information using resources described above with respect to the data center 1000 by using weight parameters calculated through one or more training techniques, such as but not limited to those described herein.

In at least one embodiment, the data center 1000 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 900 of FIG. 9—e.g., each device may include similar components, features, and/or functionality of the computing device(s) 900. In addition, where backend devices (e.g., servers, NAS, etc.) are implemented, the backend devices may be included as part of a data center 1000, an example of which is described in more detail herein with respect to FIG. 10.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 900 described herein with respect to FIG. 9. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

### EXAMPLE PARAGRAPHS

A. A method comprising: obtaining input data representing a dashed line associated with a drivable surface; generating a representation associated with the dashed line based at least on intensity values associated with points corresponding to the input data; determining, based at least on the representation, a relationship between at least a first portion of the dashed line and a second portion of the dashed line; and determining, based at least on the relationship, information associated with one or more components of the dashed line, the information including at least one or more locations associated with the one or more components.

B. The method of paragraph A, wherein the input data is first feature data obtained from mapping data, the method further comprising: generating second feature data associated with the one or more components, the second feature data including the one or more locations; and causing the mapping data to be updated to include the second feature data.

C. The method of any one of paragraphs A-B, further comprising causing, based at least on the one or more locations associated with the one or more components, a machine to perform one or more operations.

D. The method of any one of paragraphs A-C, wherein the one or more locations associated with the one or more components corresponds with at least one of one or more start points or one or more ends points associated with the one or more components.

E. The method of any one of paragraphs A-D, wherein the determining the relationship comprises: determining, based at least on the representation, that the first portion of the dashed line is associated with one or more first intensity values of the intensity values; determining, based at least on the representation, that the second portion of the dashed line is associated with one or more second intensity values of the intensity values; determining that the one or more first intensity values are greater than the one or more second intensity values; and determining, based at least on the one or more first intensity values being greater than the one or more second intensity values, that the first portion of the dashed line includes a first marked component and the second portion of the dashed line includes a spacing between the first marked component and a second marked component of the dashed line.

F. The method of any one of paragraphs A-E, wherein: the first portion includes a first marked component of the dashed line; the second portion includes a second marked component of the dashed line; and the determining the relationship comprises: determining, using a Fast Fourier Transform, a frequency associated with the representation; and determining, based at least on a period associated with the frequency, a distance between a first location associated with the first marked component and a second location associated with the second marked component.

G. The method of any one of paragraphs A-F, wherein the generating the representation comprises: determining a first bounding shape along the dashed line, the first bounding shape corresponding to a first portion of the representation associated with a first segment of the dashed line; determining a second bounding shape along the dashed line, the second bounding shape corresponding to a second portion of the representation associated with a second segment of the dashed line; orienting the first bounding shape with respect to the second bounding shape; and causing, based at least on the first bounding shape being oriented with respect to the second bounding shape, a concatenation of the first portion of the representation and the second portion of the representation.

H. The method of any one of paragraphs A-G, wherein the generating the representation comprises: determining a first intensity value based at least on one or more first intensity values from the intensity values that are associated with a first column of the points; causing the first intensity value to be plotted as a first data point of the representation; determining a second intensity value based at least on one or more second intensity values from the intensity values that are associated with a second column of the points; and causing the second intensity value to be plotted as a second data point of the representation.

I. The method of any one of paragraphs A-H, wherein the input data is an intensity image generated based at least on LiDAR data, the intensity image representing the dashed line associated with the drivable surface from a top-down perspective.

J. A system comprising: one or more processors to: obtain input data representing a feature associated with a drivable surface; generate a representation associated with the feature based at least on intensity values associated with points corresponding to the input data; and determine, based at least on the representation, one or more locations associated with one or more components of the feature.

K. The system of paragraph J, wherein the one or more processors are further to determine, based at least on the representation, a relationship between at least a first portion of the feature and a second portion of the feature, wherein the determining the one or more locations associated with the one or more components is further based at least on the relationship.

L. The system of any one of paragraphs J-K, wherein the input data is an intensity image generated based at least on LiDAR data, the intensity image representing the feature associated with the drivable surface from a top-down perspective.

M. The system of any one of paragraphs J-L, wherein the determining the one or more locations associated with the one or more components of the feature comprises: determining, based at least on the representation, that a first portion of the feature is associated with one or more first intensity values of the intensity values; determining, based at least on the representation, that a second portion of the feature is associated with one or more second intensity values of the intensity values; determining that the one or more first intensity values are greater than the one or more second intensity values; and determining, based at least on the one or more first intensity values being greater than the one or more second intensity values, that the first portion of the feature includes a first marked component and the second portion of the feature includes a spacing between the first marked component and a second marked component of the feature.

N. The system of any one of paragraphs J-M, wherein the generating the representation comprises: determining a first intensity value based at least on one or more first intensity values from the intensity values that are associated with a first column of the points; causing the first intensity value to be plotted as a first data point of the representation; determining a second intensity value based at least on one or more second intensity values from the intensity values that are associated with a second column of the points; and causing the second intensity value to be plotted as a second data point of the representation.

O. The system of any one of paragraphs J-N, wherein the generating the representation comprises: determining a first bounding shape along the feature, the first bounding shape corresponding to a first portion of the representation associated with a first segment of the feature; determining a second bounding shape along the feature, the second bounding shape corresponding to a second portion of the representation associated with a second segment of the feature; orienting the first bounding shape with respect to the second bounding shape; and causing, based at least on the first bounding shape being oriented with respect to the second bounding shape, a concatenation of the first portion of the representation and the second portion of the representation.

P. The system of any one of paragraphs J-O, wherein: a first portion of the feature includes a first marked component; a second portion of the feature includes a second marked component distinguishable from the first marked component; and the determining the one more locations associated with the one or more components comprises: determining, using a domain transformation algorithm, a frequency associated with the representation; and determining, based at least on a period associated with the frequency, a distance between a first location associated with the first marked component and a second location associated with the second marked component.

Q. The system of any one of paragraphs J-P, wherein the one or more locations associated with the one or more components corresponds with at least one of one or more start points or one or more ends points associated with the one or more components.

R. The system of any one of paragraphs J-Q, wherein the system is comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system for performing one or more deep learning operations; a system implemented using an edge device; a system implemented using a robot; a system for performing one or more generative AI operations; a system for performing operations using one or more large language models (LLMs); a system for performing one or more conversational AI operations; a system for generating synthetic data; a system for presenting at least one of virtual reality content, augmented reality content, or mixed reality content; a system incorporating one or more virtual machines (VMs); a system implemented at least partially in a data center; or a system implemented at least partially using cloud computing resources.

S. One or more processors comprising: processing circuitry to perform one or more operations using a machine based at least on one or more locations of one or more identified features in an environment of the machine, the one or more locations determined based at least on one or more representations of the one or more identified features, the one or more representations generated based at least on one or more intensity values associated with one or more points corresponding to input data representing the one or more identified features.

T. The one or more processors of paragraph S, wherein the one or more processors are comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system for performing one or more deep learning operations; a system implemented using an edge device; a system implemented using a robot; a system for performing one or more generative AI operations; a system for performing operations using one or more large language models (LLMs); a system for performing one or more conversational AI operations; a system for generating synthetic data; a system for presenting at least one of virtual reality content, augmented reality content, or mixed reality content; a system incorporating one or more virtual machines (VMs); a system implemented at least partially in a data center; or a system implemented at least partially using cloud computing resources.

What is claimed is:

1. A method comprising:
obtaining input data representing a dashed line associated with a drivable surface;
generating a representation associated with the dashed line based at least on intensity values associated with points corresponding to the input data;
determining, based at least on the representation, a relationship between at least a first portion of the dashed line and a second portion of the dashed line; and
determining, based at least on the relationship, information associated with one or more components of the dashed line, the information including at least one or more locations associated with the one or more components.

2. The method of claim 1, wherein the input data is first feature data obtained from mapping data, the method further comprising:
generating second feature data associated with the one or more components, the second feature data including the one or more locations; and
causing the mapping data to be updated to include the second feature data.

3. The method of claim 1, further comprising causing, based at least on the one or more locations associated with the one or more components, a machine to perform one or more operations.

4. The method of claim 1, wherein the one or more locations associated with the one or more components corresponds with at least one of one or more start points or one or more ends points associated with the one or more components.

5. The method of claim 1, wherein the determining the relationship comprises:
determining, based at least on the representation, that the first portion of the dashed line is associated with one or more first intensity values of the intensity values;
determining, based at least on the representation, that the second portion of the dashed line is associated with one or more second intensity values of the intensity values;
determining that the one or more first intensity values are greater than the one or more second intensity values; and
determining, based at least on the one or more first intensity values being greater than the one or more second intensity values, that the first portion of the dashed line includes a first marked component and the second portion of the dashed line includes a spacing between the first marked component and a second marked component of the dashed line.

6. The method of claim 1, wherein:
the first portion includes a first marked component of the dashed line;
the second portion includes a second marked component of the dashed line; and
the determining the relationship comprises:
determining, using a Fast Fourier Transform, a frequency associated with the representation; and
determining, based at least on a period associated with the frequency, a distance between a first location associated with the first marked component and a second location associated with the second marked component.

7. The method of claim 1, wherein the generating the representation comprises:
determining a first bounding shape along the dashed line, the first bounding shape corresponding to a first portion of the representation associated with a first segment of the dashed line;
determining a second bounding shape along the dashed line, the second bounding shape corresponding to a second portion of the representation associated with a second segment of the dashed line;
orienting the first bounding shape with respect to the second bounding shape; and
causing, based at least on the first bounding shape being oriented with respect to the second bounding shape, a concatenation of the first portion of the representation and the second portion of the representation.

8. The method of claim 1, wherein the generating the representation comprises:
determining a first intensity value based at least on one or more first intensity values from the intensity values that are associated with a first column of the points;
causing the first intensity value to be plotted as a first data point of the representation;
determining a second intensity value based at least on one or more second intensity values from the intensity values that are associated with a second column of the points; and
causing the second intensity value to be plotted as a second data point of the representation.

9. The method of claim 1, wherein the input data is an intensity image generated based at least on LiDAR data, the intensity image representing the dashed line associated with the drivable surface from a top-down perspective.

10. A system comprising:
one or more processors to:
obtain input data representing a feature associated with a drivable surface;
generate a representation associated with the feature based at least on intensity values associated with points corresponding to the input data; and
determine, based at least on the representation, one or more locations associated with one or more components of the feature.

11. The system of claim 10, wherein the one or more processors are further to determine, based at least on the representation, a relationship between at least a first portion of the feature and a second portion of the feature, wherein the determining the one or more locations associated with the one or more components is further based at least on the relationship.

12. The system of claim 10, wherein the input data is an intensity image generated based at least on LiDAR data, the intensity image representing the feature associated with the drivable surface from a top-down perspective.

13. The system of claim 10, wherein the determining the one or more locations associated with the one or more components of the feature comprises:
determining, based at least on the representation, that a first portion of the feature is associated with one or more first intensity values of the intensity values;
determining, based at least on the representation, that a second portion of the feature is associated with one or more second intensity values of the intensity values;
determining that the one or more first intensity values are greater than the one or more second intensity values; and
determining, based at least on the one or more first intensity values being greater than the one or more second intensity values, that the first portion of the feature includes a first marked component and the second portion of the feature includes a spacing between the first marked component and a second marked component of the feature.

14. The system of claim 10, wherein the generating the representation comprises:
determining a first intensity value based at least on one or more first intensity values from the intensity values that are associated with a first column of the points;
causing the first intensity value to be plotted as a first data point of the representation;
determining a second intensity value based at least on one or more second intensity values from the intensity values that are associated with a second column of the points; and
causing the second intensity value to be plotted as a second data point of the representation.

15. The system of claim 10, wherein the generating the representation comprises:
determining a first bounding shape along the feature, the first bounding shape corresponding to a first portion of the representation associated with a first segment of the feature;
determining a second bounding shape along the feature, the second bounding shape corresponding to a second portion of the representation associated with a second segment of the feature;
orienting the first bounding shape with respect to the second bounding shape; and
causing, based at least on the first bounding shape being oriented with respect to the second bounding shape, a concatenation of the first portion of the representation and the second portion of the representation.

16. The system of claim 10, wherein:
a first portion of the feature includes a first marked component;
a second portion of the feature includes a second marked component distinguishable from the first marked component; and
the determining the one more locations associated with the one or more components comprises:
determining, using a domain transformation algorithm, a frequency associated with the representation; and
determining, based at least on a period associated with the frequency, a distance between a first location associated with the first marked component and a second location associated with the second marked component.

17. The system of claim 10, wherein the one or more locations associated with the one or more components corresponds with at least one of one or more start points or one or more ends points associated with the one or more components.

18. The system of claim 10, wherein the system is comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system for performing one or more deep learning operations;
a system implemented using an edge device;
a system implemented using a robot;
a system for performing one or more generative AI operations;
a system for performing operations using one or more large language models (LLMs);
a system for performing one or more conversational AI operations;
a system for generating synthetic data;
a system for presenting at least one of virtual reality content, augmented reality content, or mixed reality content;
a system incorporating one or more virtual machines (VMs);
a system implemented at least partially in a data center; or
a system implemented at least partially using cloud computing resources.

19. One or more processors comprising:
processing circuitry to perform one or more operations using a machine based at least on one or more locations of one or more identified features in an environment of the machine, the one or more locations determined based at least on one or more representations of the one or more identified features, the one or more representations generated based at least on one or more intensity values associated with one or more points corresponding to input data representing the one or more identified features.

20. The one or more processors of claim 19, wherein the one or more processors are comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system for performing one or more deep learning operations;
a system implemented using an edge device;
a system implemented using a robot;
a system for performing one or more generative AI operations;
a system for performing operations using one or more large language models (LLMs);
a system for performing one or more conversational AI operations;
a system for generating synthetic data;
a system for presenting at least one of virtual reality content, augmented reality content, or mixed reality content;
a system incorporating one or more virtual machines (VMs);
a system implemented at least partially in a data center; or
a system implemented at least partially using cloud computing resources.
